(19) United States
(12) Patent Application Publication
(10) Pub. No.: US 2008/0303734 A1
(43) Pub. Date: Dec. 11, 2008

(54) Dielectric Leaky Wave Antenna

(76) Inventors: Tasuku Teshirogi, Tokyo (JP); Aya Hinotani, Atsugi-shi (JP); Takashi Kawamura, Atsugi-shi (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/631,426

(22) PCT Filed: Jul. 20, 2006
(86) PCT No.: PCT/JP06/14421

§ 371 Date: Jan. 3, 2007

(30) Foreign Application Priority Data
Jul. 25, 2005 (JP) 2005-214214

(51) Int. Cl. H01Q 13/28; H01Q 13/26

(52) U.S. Cl. 343/785

(57) ABSTRACT

A dielectric leakage wave antenna in which both transmission characteristics of a dielectric image line for a radiating section and those of a microstrip line for an exciting section are satisfied while enhancing efficiency by such an arrangement as a dielectric substrate has a lower layer portion and an upper layer portion bonded onto the lower layer portion. A ground plate conductor forming the dielectric image line for making an electromagnetic wave propagate through the dielectric substrate direction in a direction intersecting its thickness direction perpendicularly is formed, as one surface side of the dielectric substrate, on the lower surface of the lower layer. A plurality of leakage metal strips provided in parallel at a predetermined interval on the opposite side of the dielectric substrate are formed on the upper surface of the upper layer of the dielectric substrate. A line metal strip forming the microstrip line with the ground plate conductor constituting the exciting section, and a branching means for branching an electromagnetic wave propagating on the microstrip line to a direction intersecting the plurality of leakage metal strips in the dielectric substrate are formed between the upper and lower layers of the dielectric substrate.

### TECHNICAL FIELD

The present invention relates to a dielectric leaky wave antenna, and in particular, to a dielectric leaky wave antenna with an excitation section and a radiation section, which uses a technology for making both characteristics of the excitation section and the radiation section possible to be optimized.

### BACKGROUND ART

For example, there is a dielectric leaky wave antenna as an antenna with a simple configuration and a high efficiency, which is used in a quasi-millimeter waveband of 24.05 to 24.2 GHz assigned to Doppler radars.

FIG. 42 shows a structural example of a dielectric leaky wave antenna 10 which has been known conventionally.

In the dielectric leaky wave antenna 10, a dielectric image guide which transmits electromagnetic radiation in a direction perpendicular to a thickness direction of a dielectric substrate 11 is formed by the dielectric substrate 11 and a ground conductor 12 provided to one surface of the dielectric substrate 11 (the lower surface in the drawing). In addition, a plurality of metal strips for leakage 13 serving as a radiation section are provided at predetermined intervals in parallel to one another in a direction perpendicular to a transmission direction A of the electromagnetic radiation, at an opposite side (the upper surface in the drawing) of the dielectric substrate 11. Electromagnetic radiation to be fed from an excitation section 14 which will be described later is propagated in a direction perpendicular to the plurality of metal strips for leakage 13, whereby the electromagnetic radiation in the dielectric substrate 11 is made to leak from the surface of the dielectric substrate 11 to the exterior space.

Here, radiation characteristics of the electromagnetic radiation made to leak from the surface of the dielectric substrate 11 can be variously set in accordance with a width and an interval of the plurality of metal strips for leakage 13, and an angle between the wave front (the equiphase surface) of the electromagnetic radiation propagated in the dielectric substrate 11 and the plurality of metal strips for leakage 13.

For example, if the wave front of the electromagnetic radiation propagated in the dielectric substrate 11 is made to be parallel to the plurality of metal strips for leakage 13, a direction of beams of the electromagnetic radiation made to leak from the surface of the dielectric substrate 11 can be set in a plane which is perpendicular to the surface of the dielectric substrate 11 and perpendicular to the length direction of the plurality of metal strips for leakage 13.

Further, the direction of beams of the electromagnetic radiation in the plane is determined mainly on the basis of intervals among the plurality of metal strips for leakage 13.

For example, if the intervals among the plurality of metal strips for leakage 13 are set to be substantially the same as a propagating wavelength kg of electromagnetic radiation to be radiated in the dielectric image guide, a direction of beams of the electromagnetic radiation can be set to a direction substantially perpendicular to the surface of the dielectric substrate 11, which makes it possible to make an aspect of the dielectric substrate 11 and a direction of beams of the electromagnetic radiation substantially accord with each other.

In a dielectric leaky wave antenna which radiates electromagnetic radiation on the basis of such a principle, it is necessary to provide the excitation section 14 for propagating electromagnetic radiation having a wave front substantially parallel to the plurality of metal strips for leakage 13 in the dielectric substrate 11.

As the excitation section 14, one which can be configured with a simple configuration and high mass productivity at low cost has been proposed by the inventors in Pat. Document 1. As shown in FIG. 42, an excitation section disclosed in Pat. Document 1 has a configuration having: a metal strip for guide 15 which forms a microstrip line with a dielectric substrate 11 between itself and a ground conductor 12; and branching means 14A in which, for example, first and second stubs 16 and 17 are provided at predetermined intervals at the both sides of the metal strip for guide 15, the branching means 14A branching electromagnetic radiation propagated in the microstrip line in a direction of arrows A perpendicular to the plurality of metal strips for leakage 13.

Note that, an arrow B in the excitation section 14 shown in FIG. 42 denotes a direction of an electric field of electromagnetic radiation fed from a feed unit 18 at one end of the metal strip for guide 15 into the microstrip line formed with the dielectric substrate 11 between with the ground conductor 12.

Pat. Document 1: Jpn. Pat. Appln. KOKAI Publication No. 2004-328291

### DISCLOSURE OF INVENTION

However, when as descried above, a dielectric image guide for a radiation section and a microstrip line as an excitation section are formed on a common dielectric substrate 11, there is a new problem to be solved as follows.

Namely, in the dielectric image guide, the dielectric substrate 11 is required to have a given substrate thickness for confining an electromagnetic field. In contrast thereto, in the microstrip line, electromagnetic radiation leaks from the line itself when a substrate thickness is increased, and consequently, it is impossible to efficiently branch the electromagnetic radiation in a direction in which the plurality of metal strips for leakage 13 are provided.

Conventionally, the actual situation is such that a transmission characteristic of at least one of a dielectric image guide for a radiation section and a microstrip line as an excitation section is sacrificed.

An object of the present invention is, in order to solve the problem of the prior art as described above, to provide a dielectric leaky wave antenna which satisfies both of a transmission characteristic of a dielectric image guide for a radiation section and a transmission characteristic of a microstrip line for an excitation section, and which is made more efficient.

In order to achieve the above object, according to a first aspect of the present invention, there is provided a dielectric leaky wave antenna comprising:

a dielectric substrate (21);

a ground conductor (22) provided on one surface side of the dielectric substrate, the ground conductor forming a dielectric image guide which propagates electromagnetic radiation in a direction perpendicular to a thickness direction in the dielectric substrate;

a plurality of metal strips for leakage (23, 23′) provided in parallel to one another at predetermined intervals on an opposite surface side of the dielectric substrate; and

an excitation section (24) having a metal strip for guide (40) which forms a microstrip line between itself and the ground conductor and branching means (24A) for branching electromagnetic radiation transmitted in the microstrip line in a direction perpendicular to the plurality of metal strips for leakage in the dielectric substrate, wherein

the dielectric substrate is configured to have a lower layer portion (21a) and an upper layer portion (21b) joined on the lower layer portion,

the ground conductor is formed on a lower surface of the lower layer portion of the dielectric substrate,

the plurality of metal strips for leakage are formed on an upper surface of the upper layer portion of the dielectric substrate, and

the metal strip for guide and the branching means which configure the excitation section are formed between the lower layer portion and the upper layer portion of the dielectric substrate.

In order to achieve the above object, according to a second aspect of the present invention, there is provided the dielectric leaky wave antenna according to the first aspect, wherein

the branching means of the excitation section has:

a plurality of first stubs (41, 41′, 141) provided at predetermined intervals to an edge at one side of the metal strip for guide, the first stubs branching and outputting electromagnetic radiation, which is fed to the microstrip line and is propagated in a longitudinal direction of the microstrip line, in a direction perpendicular to the metal strips for leakage; and

a plurality of second stubs (51, 51′, 151) provided at predetermined intervals to an edge at the other side of the metal strip for guide, the second stubs branching and outputting electromagnetic radiation, which is fed to the microstrip line and is propagated in a longitudinal direction of the microstrip line, in a direction perpendicular to the metal strips for leakage, and

the predetermined intervals at which the plurality of first stubs and the plurality of second stubs are provided are equal to a guide wavelength of the electromagnetic radiation propagated in the microstrip line.

In order to achieve the above object, according to a third aspect of the present invention, there is provided the dielectric leaky wave antenna according to the second aspect, wherein

the plurality of first stubs and the plurality of second stubs are respectively provided such that corresponding stubs are shifted by substantially one fourth the guide wavelength of the electromagnetic radiation propagated in the microstrip line.

In order to achieve the above object, according to a fourth aspect of the present invention, there is provided the dielectric leaky wave antenna according to the second aspect, wherein

the plurality of first stubs and the plurality of second stubs are respectively provided at positions symmetric with respect to the metal strip for guide.

In order to achieve the above object, according to a fifth aspect of the present invention, there is provided the dielectric leaky wave antenna according to the fourth aspect, wherein

the branching means of the excitation section is provided with a plurality of reflex suppression elements respectively provided at positions symmetric with respect to the metal strip for guide at predetermined intervals respectively from the plurality of first stubs and the plurality of second stubs.

In order to achieve the above object, according to a sixth aspect of the present invention, there is provided the dielectric leaky wave antenna according to the second aspect, wherein

the plurality of first stubs and the plurality of second stubs are formed in band shapes extending by predetermined distances in a direction perpendicular to the metal strip for guide respectively with predetermined widths from the side edges of the metal strip for guide.

In order to achieve the above object, according to a seventh aspect of the present invention, there is provided the dielectric leaky wave antenna according to the fifth aspect, wherein

the plurality of reflex suppression elements are formed in band shapes extending by predetermined distances in a direction perpendicular to the metal strip for guide respectively with predetermined widths from the side edges of the metal strip for guide.

In order to achieve the above object, according to an eighth aspect of the present invention, there is provided the dielectric leaky wave antenna according to the first aspect, further comprising

a reflecting wall (70, 71) to reflect the electromagnetic radiation branched toward a side opposite to a side of the metal strips for leakage by the branching means, toward the side of the metal strips for leakage.

In order to achieve the above object, according to a ninth aspect of the present invention, there is provided the dielectric leaky wave antenna according to the first aspect, further comprising

a shield member (73, 74) having one end electrically connected to the ground conductor, and the other end extended so as to face the metal strip for guide at an opposite surface side of the dielectric substrate, the shield member shielding electromagnetic radiation directly radiated from the microstrip line to the opposite surface side of the dielectric substrate.

In order to achieve the above object, according to a tenth aspect of the present invention, there is provided the dielectric leaky wave antenna according to the first aspect, wherein

the excitation section is provided at a substantially central portion of the dielectric substrate, and the plurality of metal strips for leakage are respectively provided at both sides of the excitation section.

In order to achieve the above object, according to an eleventh aspect of the present invention, there is provided the dielectric leaky wave antenna according to the first aspect, wherein

the microstrip line is configured to propagate electromagnetic radiation fed from one end of the microstrip line to the other end of the microstrip line.

In order to achieve the above object, according to a twelfth aspect of the present invention, there is provided the dielectric leaky wave antenna according to the first aspect, wherein

the microstrip line is configured to propagate electromagnetic radiation fed from a substantially center of the microstrip line to both end sides of the microstrip line.

In order to achieve the above object, according to a thirteenth aspect of the present invention, there is provided the dielectric leaky wave antenna according to the first aspect, wherein

a circuit board (110) is provided at an opposite side of the dielectric substrate with respect to the ground conductor, and an electrode section (111) of the circuit board and a part of the metal strip for guide are connected via a slot (22a) formed in the ground conductor.

In order to achieve the above object, according to a fourteenth aspect of the present invention, there is provided the dielectric leaky wave antenna according to the first aspect, wherein

a circuit board (110) is provided at an opposite side of the dielectric substrate with respect to the ground conductor, and an electrode section (111) of the circuit board and a part of the metal strip for guide are connected via a metal pin (112) formed so as to penetrate through the lower layer portion of the dielectric substrate, the ground conductor, and the circuit board.

In order to achieve the above object, according to a fifteenth aspect of the present invention, there is provided the dielectric leaky wave antenna according to the first aspect, wherein

the metal strip for guide and the branching means which configure the excitation section are formed by a print process on an upper surface of the lower layer portion or a lower surface of the upper layer portion of the dielectric substrate.

In the dielectric leaky wave antenna of the invention configured as described above, the metal strip for guide of the excitation section is formed between a lower layer portion and an upper layer portion of the dielectric substrate. As a consequence, a thickness of the microstrip line for an excitation section can be freely set with respect to a thickness of the entire dielectric substrate required for the dielectric image guide for transmitting electromagnetic radiation to the side of the metal strips for leakage. For this reason, an attempt can be made to optimize characteristics of the dielectric image guide and the microstrip line, and an attempt can be made to make the dielectric leaky wave antenna more efficient without sacrificing both the characteristics of the guide and the line.

### BRIEF DESCRIPTION OF DRAWINGS

FIG. 1 is a perspective view showing a configuration of a first embodiment by edge feeding to which a dielectric leaky wave antenna of the invention is applied.

FIG. 2 is an exploded perspective view showing the configuration of the first embodiment by edge feeding to which the dielectric leaky wave antenna of the invention is applied.

FIG. 3 is a diagram for explaining a configuration of a principal part and operations of the first embodiment by edge feeding to which the dielectric leaky wave antenna of the invention is applied.

FIG. 4 is a diagram showing a specific configuration of the principal part of the first embodiment by edge feeding to which the dielectric leaky wave antenna of the invention is applied.

FIG. 5 is a diagram showing a configuration of a principal part of a second embodiment by edge feeding to which the dielectric leaky wave antenna of the invention is applied.

FIG. 6 is a diagram showing a configuration of a principal part of a third embodiment by edge feeding to which the dielectric leaky wave antenna of the invention is applied.

FIG. 7 is a graph for explaining an effect of reflex suppression elements of the third embodiment by edge feeding to which the dielectric leaky wave antenna of the invention is applied.

FIG. 8 is a graph for explaining a relationship between a width of metal strip for radiation and a leakage quantity in the respective embodiments to which the dielectric leaky wave antenna of the invention is applied.

FIG. 9A is a graph for explaining a relationship among changes in electric field distribution characteristics with respect to a height of a metal strip for guide in the respective embodiments to which the dielectric leaky wave antenna of the invention is applied.

FIG. 9B is a graph for explaining a relationship among changes in electric field distribution characteristics with respect to a height of a metal strip for guide of a dielectric leaky wave antenna according to a prior art.

FIG. 10 is a graph shown for explanation between a height of the metal strip for guide and a transmission loss in the respective embodiments to which the dielectric leaky wave antenna of the invention is applied.

FIG. 11 is a graph for explaining electric field distribution in the metal strip for guide when stubs are provided to the metal strip for guide in the respective embodiments to which the dielectric leaky wave antenna according to the invention is applied.

FIG. 12 is a view showing an example in which a reflective member is provided in the first embodiment to which the dielectric leaky wave antenna according to the invention is applied.

FIG. 13 is a view showing an example in which a reflecting wall constituted by metal pins is provided in the first embodiment to which the dielectric leaky wave antenna according to the invention is applied.

FIG. 14 is a view showing an example in which a shield member is provided in the first embodiment to which the dielectric leaky wave antenna according to the invention is applied.

FIG. 15 is a view showing an example in which a reflecting wall constituted by metal pins and a shield member are provided in the first embodiment to which the dielectric leaky wave antenna according to the invention is applied.

FIG. 16 is a view showing an example in which metal strips for leakage are provided at the both sides of the metal strip for guide to which edge feeding is carried out in the first embodiment to which the dielectric leaky wave antenna according to the invention is applied.

FIG. 17 is a view showing an example in which a reflective member is provided in the second embodiment to which the dielectric leaky wave antenna according to the invention is applied.

FIG. 18 is a view showing an example in which a reflecting wall constituted by metal pins is provided in the second embodiment to which the dielectric leaky wave antenna according to the invention is applied.

FIG. 19 is a view showing an example in which a shield member is provided in the second embodiment to which the dielectric leaky wave antenna according to the invention is applied.

FIG. 20 is a view showing an example in which a reflecting wall constituted by metal pins and a shield member are provided in the second embodiment to which the dielectric leaky wave antenna according to the invention is applied.

FIG. 21 is a view showing an example in which metal strips for leakage are provided at the both sides of the metal strip for guide to which edge feeding is carried out in the second embodiment to which the dielectric leaky wave antenna according to the invention is applied.

FIG. 22 is a view showing an example in which a reflective member is provided in the third embodiment to which the dielectric leaky wave antenna according to the invention is applied.

FIG. 23 is a view showing an example in which a reflecting wall constituted by metal pins is provided in the third embodiment to which the dielectric leaky wave antenna according to the invention is applied.

FIG. 24 is a view showing an example in which a shield member is provided in the third embodiment to which the dielectric leaky wave antenna according to the invention is applied.

FIG. 25 is a view showing an example in which a reflecting wall constituted by metal pins and a shield member are provided in the third embodiment to which the dielectric leaky wave antenna according to the invention is applied.

FIG. 26 is a view showing an example in which metal strips for leakage are provided at the both sides of the metal strip for guide to which edge feeding is carried out in the third embodiment to which the dielectric leaky wave antenna according to the invention is applied.

FIG. 27 is a perspective view showing a configuration of a fourth embodiment by center feeding to which the dielectric leaky wave antenna of the invention is applied.

FIG. 28 is a diagram for explaining a configuration and operations of a principal part of the fourth embodiment by center feeding to which the dielectric leaky wave antenna of the invention is applied.

FIG. 29 is a view showing an example in which metal strips for leakage are provided at the both sides of the metal strip for guide to which center feeding is carried out in the fourth embodiment to which the dielectric leaky wave antenna according to the invention is applied.

FIG. 30 is a diagram showing a configuration of a principal part of a fifth embodiment by center feeding to which the dielectric leaky wave antenna of the invention is applied.

FIG. 31 is a diagram showing a configuration of a principal part of a sixth embodiment by center feeding to which the dielectric leaky wave antenna of the invention is applied.

FIG. 32 is a perspective view showing a configuration of the fifth embodiment by center feeding to which the dielectric leaky wave antenna of the invention is applied.

FIG. 33 is a view showing an example in which metal strips for leakage are provided at the both sides of the metal strip for guide to which center feeding is carried out in the fifth embodiment to which the dielectric leaky wave antenna according to the invention is applied.

FIG. 34 is a perspective view showing a configuration of the sixth embodiment by center feeding to which the dielectric leaky wave antenna of the invention is applied.

FIG. 35 is a view showing an example in which metal strips for leakage are provided at the both sides of the metal strip for guide to which center feeding is carried out in the sixth embodiment to which the dielectric leaky wave antenna according to the invention is applied.

FIG. 36 is a view showing an example an antenna of 45° polarization in a seventh embodiment to which the dielectric leaky wave antenna of the invention is applied.

FIG. 37 is a diagram showing a modified example of the excitation section in the respective embodiments to which the dielectric leaky wave antenna according to the invention is applied.

FIG. 38 is a diagram showing another modified example of the excitation section in the respective embodiments to which the dielectric leaky wave antenna according to the invention is applied.

FIG. 39 is a view showing a configuration example when edge feeding is carried out via a slot in the first embodiment by edge feeding to which the dielectric leaky wave antenna according to the invention is applied.

FIG. 40 is a view showing a configuration example when center feeding is carried out via a slot in the fourth embodiment by center feeding to which the dielectric leaky wave antenna according to the invention is applied.

FIG. 41 is a view showing a configuration example when feeding is carried out via a metal pin in the respective embodiments to which the dielectric leaky wave antenna according to the invention is applied.

FIG. 42 is a perspective view showing a configuration of a conventional dielectric leaky wave antenna.

### BEST MODE FOR CARRYING OUT THE INVENTION

Hereinafter, embodiments of the present invention will be described with reference to the drawings.

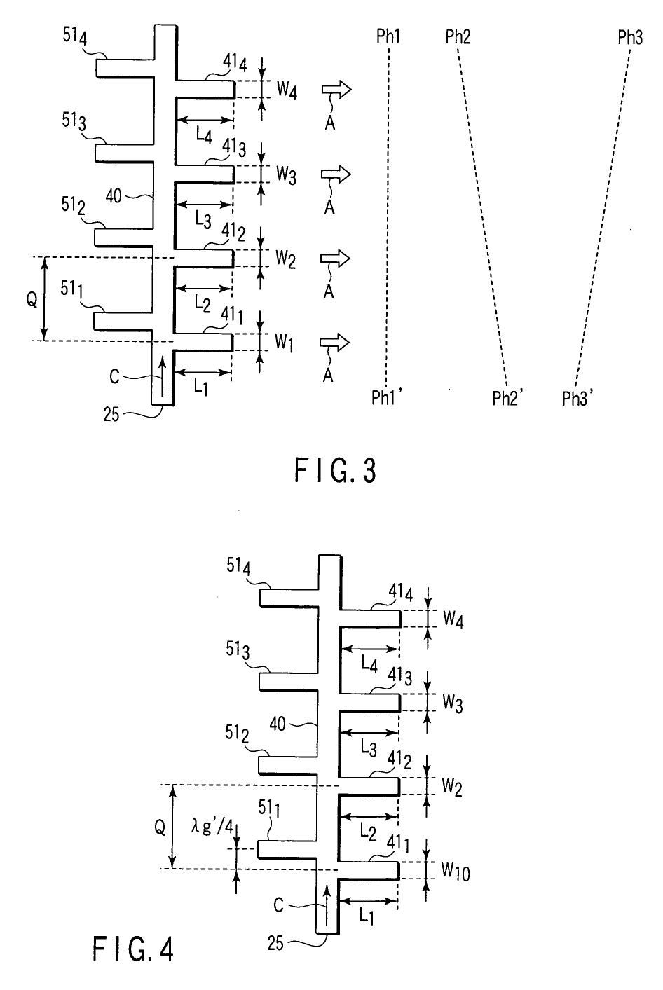

First, the brief summary of the present invention will be described. In the invention, as shown in FIGS. 3, 4, 5, 6, 28, 30, 31, 37 and 38, there are examples of respective embodiments of metal strips for guide 40 and 40′ including branching means serving as excitation sections.

These are respectively used for first, second, third, fourth, fifth, and sixth embodiments (which will be described later) to which a dielectric leaky wave antenna according to the invention is applied, and modified examples of the excitation sections in these embodiments.

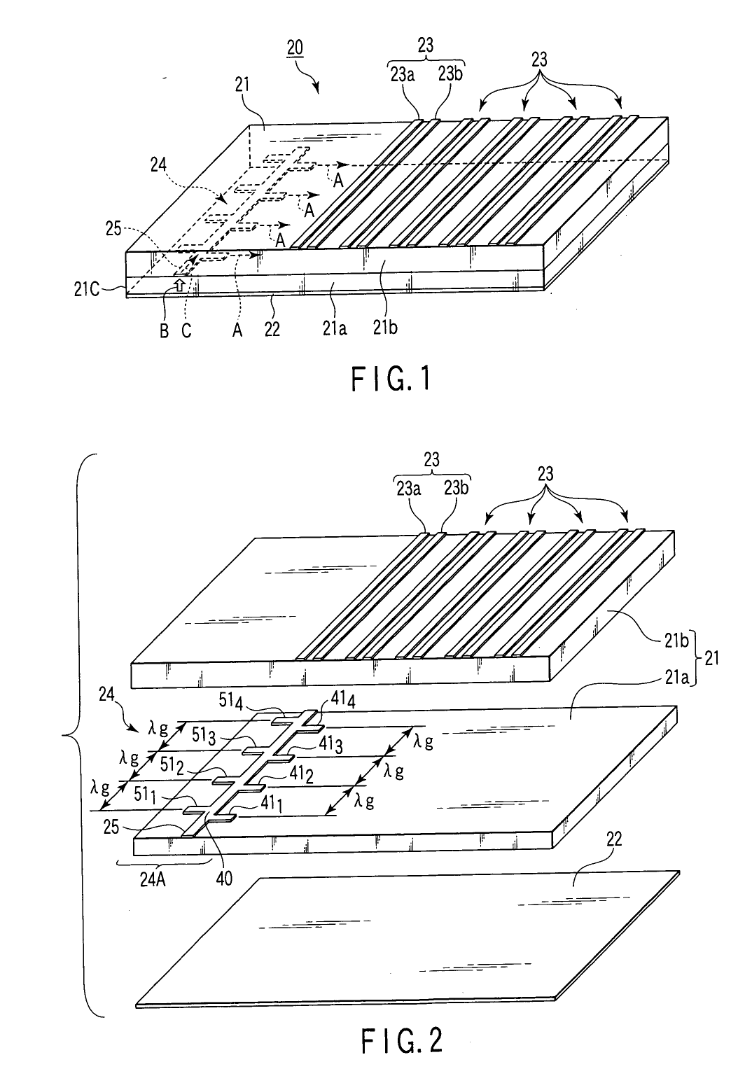

Further, examples of the embodiments of radiation sections including a plurality of metal strips for leakage 23 arranged on one side of the excitation sections are shown in FIGS. 1, 2, 12, 13, 14, 15, 17, 18, 19, 20, 22, 23, 24, 25, 27 and 34.

These are respectively used for the first, second, third, fourth, fifth, and sixth embodiments (which will be described later) to which the dielectric leaky wave antenna according to the invention is applied.

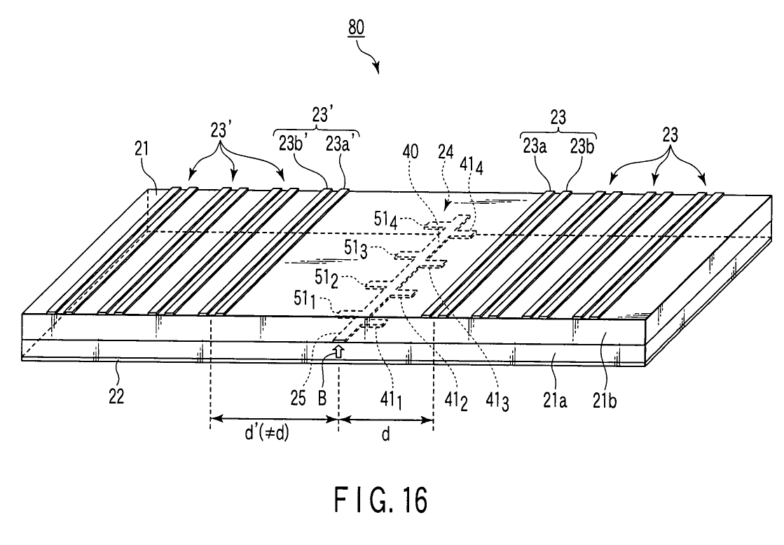

Moreover, examples of the embodiments of radiation sections including a plurality of metal strips for leakage 23 arranged on the both sides of the excitation sections are shown in FIGS. 16, 21, 26, 29, 33, 35 and 36.

These are respectively used for the first, second, third, fourth, fifth, sixth, and seventh embodiments (which will be described later) to which the dielectric leaky wave antenna according to the invention is applied.

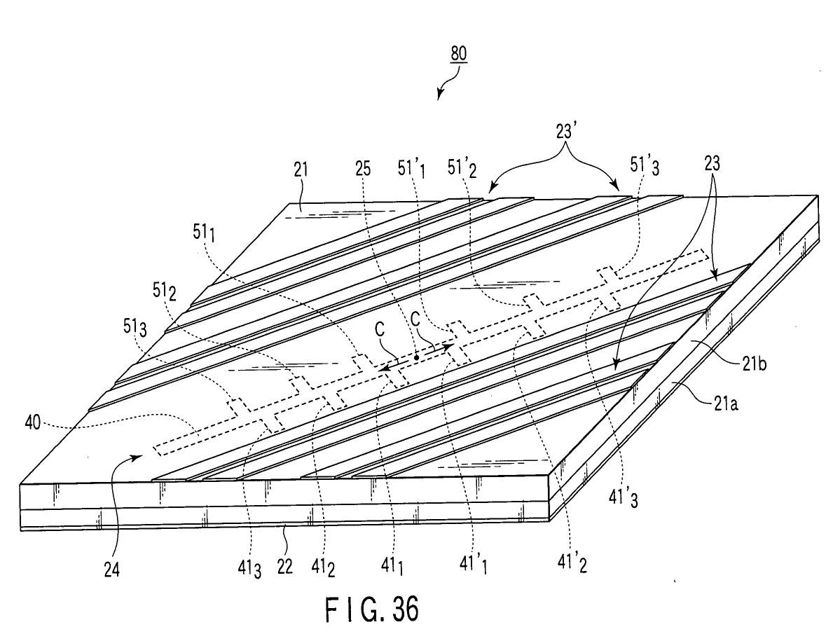

Here, the seventh embodiment shown in FIG. 36 is an example of an antenna of 45° polarization by center feeding to which the dielectric leaky wave antenna of the invention is applied.

Note that an aspect according to the first embodiment described with reference to FIGS. 1 and 2 is applied to overall the first, second, third, fourth, fifth, and sixth embodiments. Here, description will be given to a case in which a specific example of the metal strip for guide 40 including branching means serving as an excitation section shown in FIGS. 3 and 4 is used.

### FIRST EMBODIMENT

FIGS. 1 and 2 show configurations of a dielectric leaky wave antenna 20 according to the first embodiment to which the invention is applied.

Namely, FIG. 1 is a perspective view showing a configuration of the first embodiment by edge feeding to which the dielectric leaky wave antenna of the invention is applied.

Further, FIG. 2 is an exploded perspective view showing a configuration of the first embodiment by edge feeding to which the dielectric leaky wave antenna of the invention is applied.

The dielectric leaky wave antenna 20 basically includes: a dielectric substrate 21; a ground conductor 22 provided to one surface side of the dielectric substrate, the ground conductor 22 forming a dielectric image guide which propagates electromagnetic radiation in a direction perpendicular to a thickness direction in the dielectric substrate; a plurality of metal strips for leakage 23 provided in parallel to one another at predetermined intervals at an opposite surface side of the dielectric substrate 21; and an excitation section 24 having a metal strip for guide 40 which forms a microstrip line between itself and the ground conductor 22, and branching means 24A for branching electromagnetic radiation transmitted in the microstrip line in a direction perpendicular to the plurality of metal strips for leakage 23 in the dielectric substrate. The dielectric substrate 21 is configured to have a lower layer portion 21a and an upper layer portion 21b joined onto the upper surface of the lower layer portion 21a, and the ground conductor 22 is formed on the lower surface of the lower layer portion 21a of the dielectric substrate 21. The plurality of metal strips for leakage 23 are formed on the upper surface of the upper layer portion 21b of the dielectric substrate 21. The metal strip for guide 40 and the branching means 24A which configure the excitation section 24 are formed between the lower layer portion 21a and the upper layer portion 21b of the dielectric substrate 21.

Specifically, the dielectric leaky wave antenna 20 is, for example, an antenna which covers a 24.05 to 24.2 GHz frequency band for use in Doppler radars or the like within a quasi-millimeter waveband.

In the dielectric leaky wave antenna 20, as described above, a dielectric image guide which allows electromagnetic radiation to be propagated in a direction of the arrows A perpendicular to the thickness direction in the dielectric substrate 21 is formed by the dielectric substrate 21 and the ground conductor 22 provided to be joined so as to overlap onto one surface side (the lower surface side) of the dielectric substrate 21 with no space.

Further, the plurality of metal strips for leakage 23 are provided at predetermined intervals, for example, at intervals which are substantially equal to a guide wavelength λg of electromagnetic radiation propagated in the dielectric image guide, onto the opposite surface side (the upper surface side) of the dielectric substrate 21.

Note that the ground conductor 22 and the plurality of metal strips for leakage 23 are formed by a print process or etching process of a metal film onto the dielectric substrate 21.

The dielectric substrate 21 is made of alumina, ceramic, various types of resins, or the like, and has a structure of at least two layers in which the lower layer portion 21a and the upper layer portion 21b are overlapped with each other to be joined together.

Dielectric materials of identical material are generally used as the lower layer portion 21a and upper layer portion 21b. However, different types of materials may be also used.

The plurality of metal strips for leakage 23 formed on the surface of the upper layer portion 21b of the dielectric substrate 21 are respectively composed of two metal strips 23a and 23b separated by substantially one fourth the guide wavelength kg in parallel to each other in order to suppress reflective components generated in the dielectric image guide.

In this case, when the plurality of metal strips for leakage 23 are composed of only the metal strips 23a at intervals substantially equal to the guide wavelength λg, reflected waves generated by the metal strips 23a are made to be in phase, which degrades the radiant efficiency as an antenna.

However, the metal strips 23b in the same size as the metal strips 23a are respectively provided at positions separated by substantially one fourth the guide wavelength λg from the metal strips 23a as described above. As a consequence, reflected waves from the both are made to have phases reversed each other, which makes it possible to set off the reflective components. Therefore, it is possible to suppress deterioration in the radiant efficiency as an antenna.

The metal strips 23a and 23b each have a function of leaking electromagnetic radiation. For this reason, when each of the plurality of metal strips for leakage 23 is constituted by the two metal strips 23a and 23b as described above, the radiant efficiency of electromagnetic radiation leaked from the surface of the dielectric substrate 21 is made to be radiant efficiency in which radiant efficiencies of electromagnetic radiation respectively made to leak by the two metal strips 23a and 23b are synthesized.

In this embodiment and all embodiments which will be shown hereinafter, each of the plurality of metal strips for leakage 23 is constituted by the two metal strips 23a and 23b.

However, the invention is not limited thereto. When reflective components by the metal strips are little enough to be ignored, each metal strip for leakage 23 may be composed of one metal strip.

In addition, it is possible to suppress reflected waves by setting the intervals among the plurality of metal strips for leakage 23 to be shorter or longer than the guide wavelength kg. Consequently, even in such a case, each of the plurality of metal strips for leakage 23 can be constituted by one metal strip.

On the other hand, the excitation section 24 is formed at a position separated from the plurality of metal strips for leakage 23, and in the inside at one end side of the dielectric substrate 21 to the left in the drawing, i.e., between the lower layer portion 21a and the upper layer portion 21b of the dielectric substrate 21.

The excitation section 24 is composed of the metal strip for guide 40 which extends in a band shape in parallel to the plurality of metal strips for leakage 23, the metal strip for guide forming a microstrip line between itself and the ground conductor 22, a plurality of (four simply shown in FIGS. 1 and 2) stubs 41₁ to 41₄ provided at predetermined intervals at one side edge (an edge on a side where the plurality of metal strips for leakage 23 are provided in FIGS. 1 and 2) of the metal strip for guide 40, and a plurality of (four simply shown in FIGS. 1 and 2) stubs 51₁ to 51₄ provided at the other side edge (the side edge on the opposite side where the plurality of metal strips for leakage 23 are provided in FIGS. 1 and 2) of the metal strip for guide 40.

The metal strip for guide 40 and the respective stubs 41 and 51 which configure the excitation section 24 are formed by a print process or etching process of a metal film onto the upper surface side of the lower layer portion 21a or the lower surface side of the upper layer portion 21b before the dielectric substrate 21 is formed in such a manner that the lower layer portion 21a and the upper layer portion 21b are overlapped with each other to be joined together.

Here, the metal strip for guide 40 forms a microstrip line with the lower layer portion 21a of the dielectric substrate 21 between itself and the ground conductor 22, which propagates electromagnetic radiation fed from the edge with an electric field in the direction of arrow B from a feed point 25 at the one end side to the other end side in the direction of arrow C.

Then, the respective stubs 41 and 51 function as the branching means 24A for branching the electromagnetic radiation propagated from the one end side to the other end side of the microstrip line in the direction of arrows A in which the metal strips for leakage 23 are provided in the dielectric substrate 21.

Note that a method for supplying electromagnetic radiation to the feed point 25 will be described later.

A transmission characteristic of the excitation section 24 can be arbitrarily set in accordance with a width of the metal strip for guide 40, widths, lengths, and intervals, etc. of the respective stubs 41 and 51.

FIG. 3 is a diagram for explaining a configuration and operations of a principal part in the first embodiment by edge feeding to which the dielectric leaky wave antenna of the invention is applied.

Namely, as shown in the left of FIG. 3, amplitudes of the excitation waves branched to be output from the respective stubs 41 and 51 depend on widths W1 to W4 and lengths L1 to L4 of the respective stubs 41 and 51. Consequently, it is possible to arbitrarily set an amplitude characteristic of the entire excitation waves in accordance with widths and lengths of the stubs.

Further, because phases of the excitation waves branched to be output from the respective stubs depend on an interval Q between stubs, it is possible to arbitrarily set a phase characteristic of the entire excitation waves in accordance with an interval between the stubs.

For example, when the interval Q is set to an integer multiple of a guide wavelength λg′ (Q=λg′), phases of the excitation waves respectively branched to be output from the first stubs 41₁ to 41₄ portions are made equal to one another, and a phase front of the entire excitation waves is made parallel to the metal strip for guide 40 as Ph1-Ph1′ shown in the right of FIG. 3.

Assume that, in this way, such excitation waves with the phase front Ph1-Ph1′ which is parallel to the metal strip for guide 40 are propagated to the side of the plurality of metal strips for leakage 23 which are parallel to the metal strip for guide 40. In this case, it is possible to radiate electromagnetic radiation whose central beam direction is perpendicular to the surface of the dielectric substrate 21, and which is located on a plane perpendicular to the metal strip for guide 40, from the surface of the dielectric substrate 21.

Further, when the interval Q is set to be shorter than an integer multiple of the guide wavelength λg′ (Q<λg′), phases of the excitation waves respectively branched to be output from the first stubs 41₁ to 41₄ portions are made to gradually advance, and a phase front of the entire excitation waves is slightly inclined toward the metal strip for guide 40 as Ph2-Ph2′ shown in the right of FIG. 3. In contrast thereto, when the interval Q is set to be longer than an integer multiple of the guide wavelength λg′ (Q>λg′), phases of the excitation waves respectively branched to be output from the first stubs 41₁ to 41₄ portions are made to gradually delay, and a phase front of the entire excitation waves is slightly inclined in the opposite direction from the Ph2-Ph2′ with respect to the metal strip for guide 40 as Ph3-Ph3′ shown in the right of FIG. 3.

In this way, the excitation waves with the phase fronts Ph2-Ph2′ and Ph3-Ph3′ inclined toward the metal strip for guide 40 are propagated toward the side of the plurality of metal strips for leakage 23 which are parallel to the metal strip for guide 40. As a result, it is possible to radiate electromagnetic radiation whose central beam direction is inclined toward the feeding end side or the terminal end side from the surface of the dielectric substrate 21.

FIG. 4 is a diagram showing a specific configuration of the principal part of the first embodiment by edge feeding to which the dielectric leaky wave antenna of the invention is applied.

Namely, as one specific configuration example, as shown in FIG. 4, the first stubs 41₁-41₄ and the second stubs 51₁-51₄ are provided in an extended condition alternately in band shapes respectively with widths of W1, W2, W3, and W4, and respectively with lengths of L1, L2, L3, and L4 from the side edges of the metal strip for guide 40.

Note that in some cases, the excitation section 24 having the configuration shown in FIGS. 1 to 4 is called an excitation section 24 having alternate stubs.

The interval Q among the first stubs 41₁ to 41₄ is set to a value approximate an integer multiple of the wave length λg′ in the microstrip line (metal strip for guide) of electromagnetic radiation to be radiated. Thus, the electromagnetic radiation, which is fed by the feed point 25 to be propagated from the one end side to the other end side of the microstrip line, is branched to be output as excitation waves in the direction of arrows A (refer to FIG. 1) in which the plurality of metal strips for leakage 23 are provided in the dielectric substrate 21.

Further, in the same manner as in the case of the two metal strips 23a and 23b of each of the plurality of metal strips for leakage 23 described above, the second stubs 51₁ to 51₄ are to set off the reflective components by generating reflective components with reversed phases of the reflective components generated by the first stubs 41₁ to 41₄. The second stubs 51₁ to 51₄ are respectively provided at positions separated by one fourth the guide wavelength λg′ of the electromagnetic radiation propagated in the microstrip line from the first stubs 41₁ to 41₄.

### SECOND EMBODIMENT

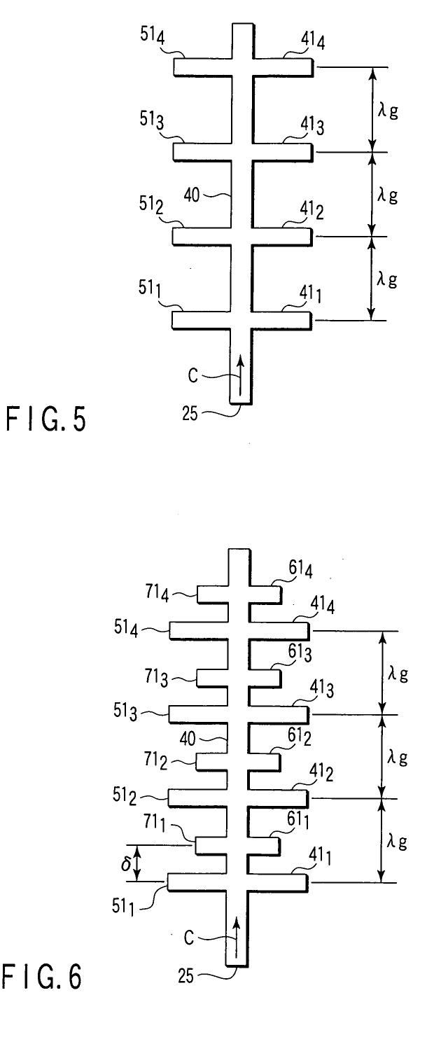

FIG. 5 is a diagram showing a configuration of a principal part of a second embodiment by edge feeding to which the dielectric leaky wave antenna of the invention is applied.

More specifically, as another configuration example in place of the excitation section 24 having alternate stubs according to the first embodiment described above, the respective elements of the first stubs 41₁ to 41₄ and the respective elements of the second stubs 51₁ to 51₄ corresponding to the first stubs 41₁ to 41₄ are, as shown in FIG. 5, arranged at positions symmetric with respect to the microstrip line (metal strip for guide 40) in the second embodiment.

With such an arrangement, electric currents opposite to each other are made to respectively flow in the elements of the first stubs 41₁ to 41₄ and the elements of the corresponding second stubs 51₁ to 51₄, and therefore, radio wave is not radiated from these stub elements to the upper surface of the dielectric substrate 21.

Accordingly, because radio wave radiation to the upper surface of the dielectric substrate 21 is not brought about, the electromagnetic radiation transmitted in the microstrip line is efficiently branched to be output as excitation waves in a direction in which the plurality of metal strips for leakage 23 are provided in the dielectric substrate 21.

However, in the configuration of FIG. 5 described above as is, reflection from the respective stubs 41 and 51 may be problematic in some cases.

In particular, when an interval among the respective stubs 41 and 51 is substantially equal to the wavelength of the electromagnetic radiation propagated in the microstrip line, reflection from the respective stub elements returns to the feed point 25 so as to be in plane, which becomes great reflection, and the radiant efficiency as an antenna is degraded.

Note that in some cases, the excitation section 24 having the configuration shown in FIG. 5 is called an excitation section 24 having symmetric stubs.

### THIRD EMBODIMENT

FIG. 6 is a diagram showing a configuration of a principal part of a third embodiment by edge feeding to which the dielectric leaky wave antenna of the invention is applied.

Namely, the third embodiment is provided as a configuration example in place of the excitation section 24 having alternate stubs according to the first embodiment described above. That is, as shown in FIG. 6, the respective elements of the first stubs 41₁ to 41₄ and the respective elements of the second stubs 51₁ to 51₄ corresponding to first stubs 41₁ to 41₄ are arranged at positions symmetric with respect to the microstrip line (metal strip for guide 40). In addition, reflex suppression (stub) elements 61₁ to 61₄ and 71₁ to 71₄ having a predetermined length are arranged between the elements of the first stubs 41₁ to 41₄ and the elements of the second stubs 51₁ to 51₄, at predetermined intervals a from the elements of the first stubs 41₁ to 41₄ and the elements of the second stubs 51₁ to 51₄.

In this way, if the reflex suppression elements 61₁ to 61₄ and 71₁ to 71₄ are arranged at predetermined intervals δ from the elements of the first stubs 41₁ to 41₄ and the elements of the second stubs 51₁ to 51₄, it is possible to reduce occurrence of reflection which is problematic in the second embodiment.

Note that the predetermined intervals δ at which the reflex suppression (stub) elements 61₁ to 61₄ and 71₁ to 71₄ are arranged from the elements of the first stubs 41₁ to 41₄ and the elements of the second stubs 51₁ to 51₄ are, for example, a value of about ½ the guide wavelength λg′, and an appropriate value is experimentally found.

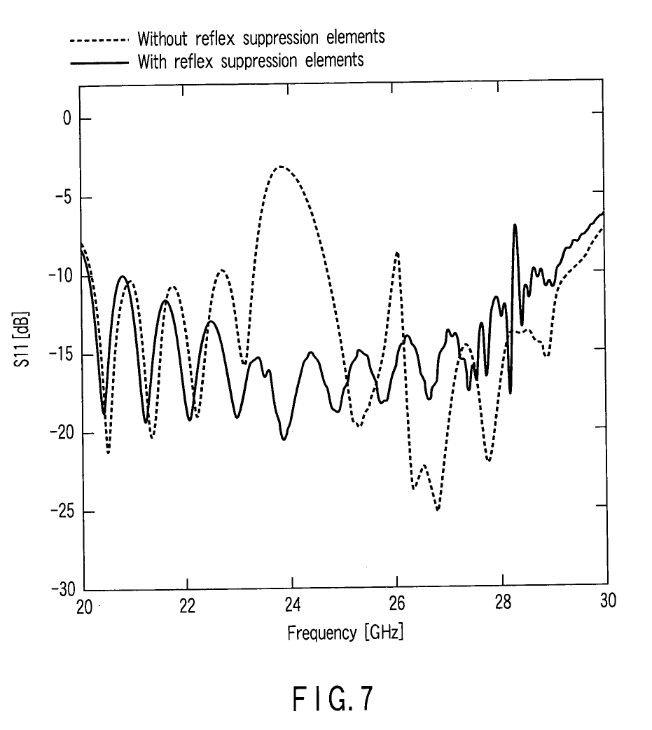

FIG. 7 is a result of simulation showing an effect of the reflex suppression elements 61₁ to 61₄ and 71₁ to 71₄.

As is clear from FIG. 7, in the case of the broken line in the drawing with no reflex suppression elements, great reflection is brought about in the vicinity of the mean frequency 24 GHz. In contrast thereto, in the case of the solid line in the drawing with reflex suppression elements, reflection is greatly suppressed.

Note that in some cases, the excitation section 24 having the configuration shown in FIG. 6 is called an excitation section 24 having reflex suppression elements.

### COMMON IN THE FIRST TO THIRD EMBODIMENTS

With respect to the dielectric leaky wave antenna 20 according to the first to third embodiments configured as described above, the dielectric substrate 21 is made to have a structure of at least two layers, which is a structure in which the metal strip for guide 40 configuring a microstrip line of the excitation section 24 is provided in the inside of the dielectric substrate 21. For this reason, an attempt can be made to respectively optimize the dielectric image guide for leakage and the microstrip line for excitation without sacrificing transmission characteristics of the both.

Namely, a thickness of the entire dielectric substrate 21 is set to a thickness t which is necessary and sufficient for confining an electromagnetic field in the dielectric image guide for leakage, and it suffices to set a thickness or the like within the entire thickness t such that the transmission characteristic of the microstrip line for excitation is made favorable.

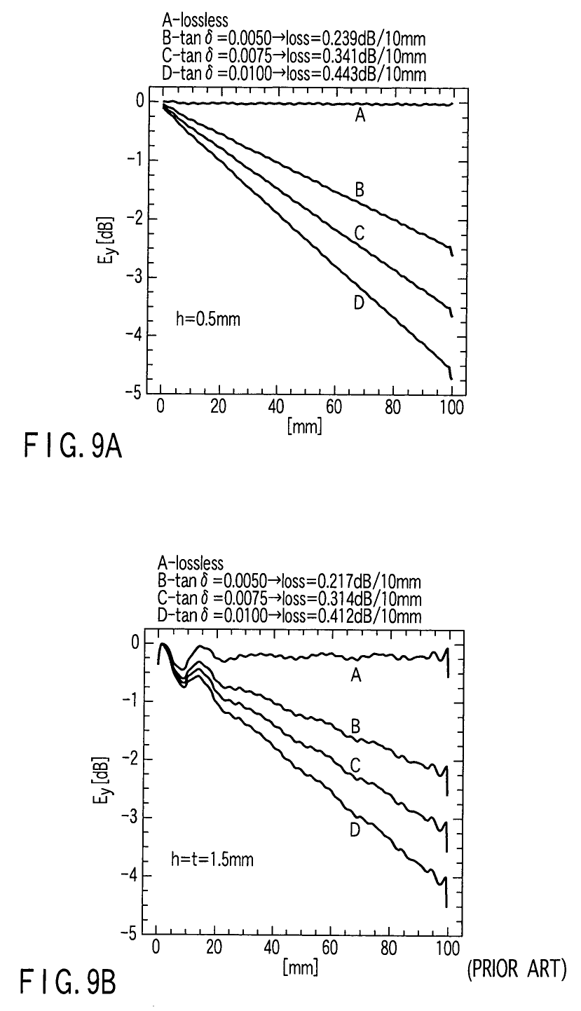

FIG. 9A shows electric field distributions of the microstrip lines for each type of the dielectric substrate (here shown by a value of dielectric loss tan δ) given that an entire thickness t of the dielectric substrate 21 is set to 1.5 mm, and a thickness h of the lower layer portion 21a is set to 0.5 mm.

FIG. 9B shows electric field distributions of the microstrip lines given that an entire thickness t of the dielectric substrate 21 and a thickness h of the lower layer portion 21a are both 1.5 mm, which are equal to each other (corresponding to a dielectric leaky wave antenna with a conventional structure).

Note that the electric field distributions are characteristics of the metal strip for guide 40 itself determined by omitting the stubs 41 and 51.

It is clear that, in the electric field distributions of the dielectric leaky wave antenna with the conventional structure, great turbulence is brought about in a region near the feed point, and a loss (inclination) varies overall.

These turbulence and variation show that the electromagnetic radiation leaks from the microstrip line itself in the vicinity of the feed point because the dielectric substrate is too thick.

In contrast thereto, it is clear that, in the electric field distributions of the dielectric leaky wave antenna 20 of the invention shown in FIG. 9A, as compared with those of the dielectric leaky wave antenna with the conventional structure, there are no turbulence and variation in a region near the feed point, the distributions monotonously change substantially linearly in accordance with a distance, and there is no leakage from the microstrip line itself because the dielectric substrate of the microstrip line is made thin.

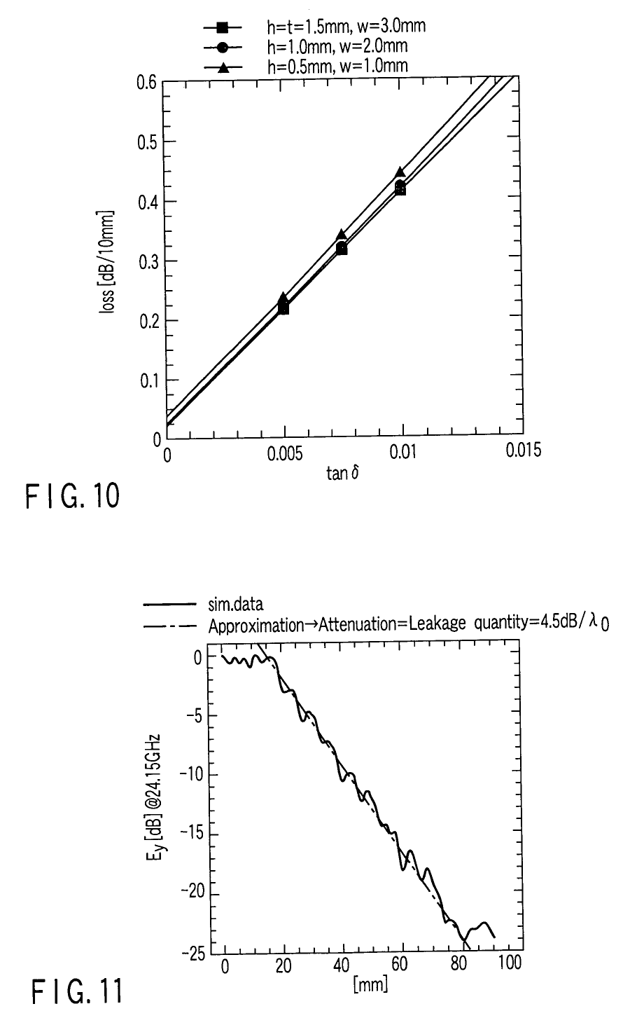

FIG. 10 is a graph for explaining a relationship between a height of the metal strip for guide and a transmission loss in the respective embodiments to which the dielectric leaky wave antenna of the invention is applied.

Namely, a surface side of a metal strip for guide is opened in a general microstrip line, while the microstrip line in the respective embodiments described above is covered with dielectric.

However, as shown in FIG. 10, it is clear that there is almost no variation in the transmission losses in the case where the metal strip for guide is on the surface of the dielectric substrate 21 (h=t), and the case where the metal strip for guide is in the inside of the dielectric substrate 21 (h<t).

FIG. 11 shows an electric field distribution on the microstrip line when the stubs 41 and 51 are provided.

This electric field distribution is reduced at a substantially constant slope, and a quantity of the reduction is output as an excitation wave.

Accordingly, it is found that the excitation section 24 is formed in the inside of the dielectric substrate 21, whereby it is possible to output uniform excitation waves to the side of the plurality of metal strips for leakage 23.

As described above, it is clear that a thickness of the dielectric substrate 21 cannot be made too thick with respect to the metal strip for guide 40.

In contrast thereto, a thickness of the dielectric substrate 21 cannot be made too thin with respect to the plurality of metal strips for leakage 23.

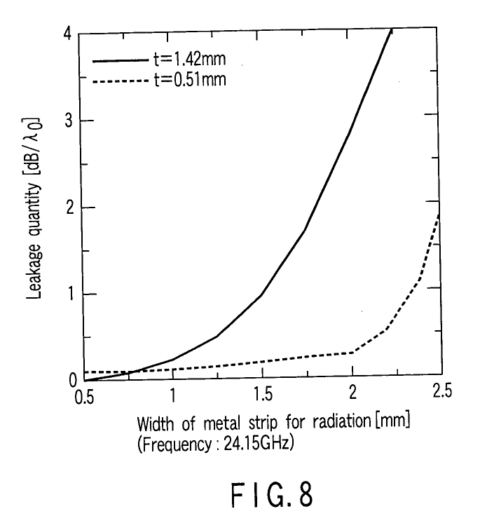

FIG. 8 is a graph showing leakage quantities per free space wave length when a width of the plurality of metal strips for leakage 23 is changed in the case where the thickness t of the dielectric substrate 21 is 1.42 mm, and in the case where the thickness t of the dielectric substrate 21 is 0.5 mm.

More specifically, it is clear from FIG. 8 that, when the thickness t of the dielectric substrate 21 is 1.42 mm, it is possible to control a leakage quantity within a broad range in accordance with a width of each metal strip for leakage 23a, while when the thickness t of the dielectric substrate 21 is 0.5 mm, there is almost no variation in a leakage quantity.

Then, when the width of each metal strip for leakage 23a is made to be approximate 2.5 mm, a leakage quantity is increased. However, not only a leakage quantity is still little, but also an interval with the other metal strip for leakage 23b serving as a reflex suppression element is made extremely narrow in accordance with the width.

Therefore, joints between the metal strips for leakage 23a and the other side metal strips for leakage 23b are made large, which disturbs the electric field distribution. As a result, an effect of suppressing reflection is lost.

Namely, it is found that the thickness of the dielectric substrate 21 with respect to the respective metal strips for leakage 23 must be made thicker than the thickness of the dielectric substrate 21 with respect to the microstrip line of the excitation section 24.

According to the invention, it is possible to realize a high-performance dielectric leaky wave antenna by providing thicknesses which are optimum for both of the respective metal strips for leakage 23 and the microstrip line for excitation as the thickness of the dielectric substrate 21.

Here, description has been given to an example in which the metal strip for guide 40 is provided so as to be parallel to the plurality of metal strips for leakage 23.

However, the metal strip for guide 40 may be at a slope toward the plurality of metal strips for leakage 23.

In this way, the excitation section 24 of the dielectric leaky wave antenna 20 in the respective embodiments described above has the metal strip for guide 40, the plurality of first stubs 41 and the reflex suppression second stubs 51. The metal strip for guide 40 is separated from the plurality of metal strips for leakage 23 on the surface of the dielectric substrate 21, is provided between the lower layer portion 21a and the upper layer portion 21b of the dielectric substrate 21, and forms a microstrip line between itself and the ground conductor 2. The first stubs 41 and reflex suppression second stubs 51 are provided at predetermined intervals at the side edges of the metal strip for guide 40, and branch and output electromagnetic radiation fed into the microstrip line in a direction perpendicular to the plurality of metal strips for leakage 23.

Consequently, the excitation section 24 can be integrated with the dielectric substrate 21, and the entire antenna can be downsized.

Further, the dielectric substrate 21 is formed such that the lower layer portion 21a and the upper layer portion 21b are overlapped to be joined together, and the excitation section 24 composed of the metal strip for guide 40 and the respective stubs 41 and 51 is formed between the lower layer portion 21a and the upper layer portion 21b. For this reason, it is possible to freely set a thickness of the microstrip line for excitation with respect to an entire thickness of the dielectric substrate 21 necessary for the dielectric image guide for transmitting electromagnetic radiation toward the side of the plurality of metal strips for leakage 23. Thus, an attempt can be made to optimize the transmission characteristics of the guides, and it is possible to make radiation as the entire antenna highly efficient without sacrificing the characteristics of the both guides.

As described above, even when the excitation section 24 is formed in the inside of the dielectric substrate 21, it suffices to form the metal strip for guide 40 and the respective stubs 41 and 51 by a print process or etching process at the upper surface side of the lower layer portion 21a or the lower surface side of the upper layer portion 21b before the lower layer portion 21a and the upper layer portion 21b are overlapped to be joined together. Consequently, the antennas can be manufactured at low cost and easily with fewer processes, which makes it possible to produce such antennas in large quantities.

Such a manufacturing process can be achieved easily by using a multilayer printed board technology.

When, in the dielectric leaky wave antenna 20 with the above-described configuration, the components of the excitation wave branched toward a side opposite to the side at which the plurality of metal strips for leakage 23 are provided are great enough not to be ignored, it is necessary to allow the excitation wave branched toward the opposite side to be reflected to the side at which the metal strips for leakage 23 are provided.

In this case, an end face 21c of the dielectric substrate 21 on the side at which the metal strip for guide 40 is provided can be utilized as a reflecting wall if the dielectric substrate 21 with a great relative permittivity such as ceramic or alumina is used.

At that time, it suffices to set distances from the position of the reflecting wall to the metal strip for guide 40 and the plurality of metal strips for leakage 23 such that phases of reflected waves which reflect from the end face 21c of the dielectric substrate 21, and go toward the side at which the plurality of metal strips for leakage 23 are provided, and of excitation waves which go directly toward the side at which the plurality of metal strips for leakage 23 are provided from the metal strip for guide 40, accord with one another.

In addition, when the dielectric substrate 21 with a little relative permittivity such as Teflon (registered trademark) as resin fluoride is used, electromagnetic radiation is radiated from the end face, which may greatly degrade the radiant efficiency as the entire antenna.

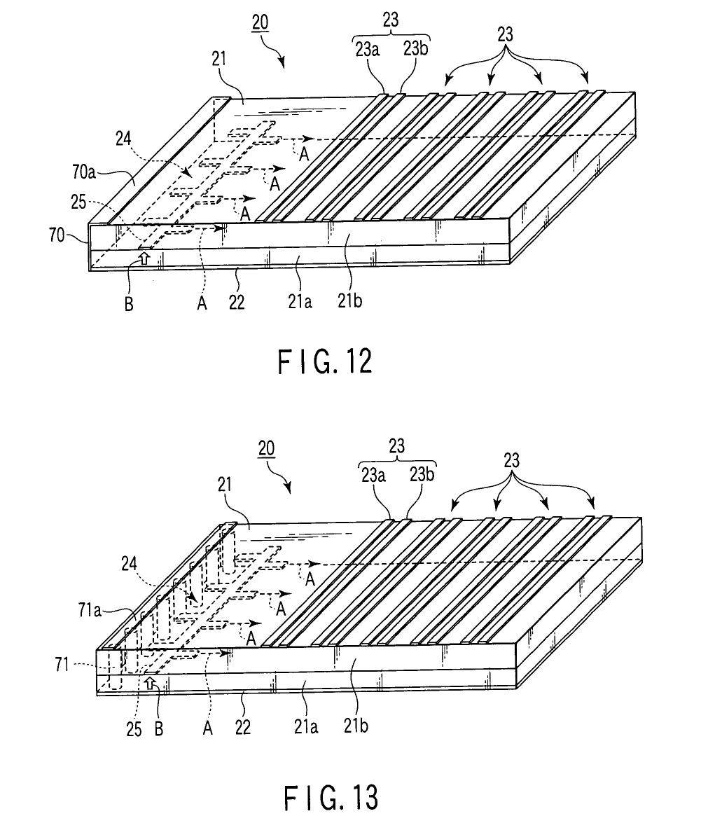

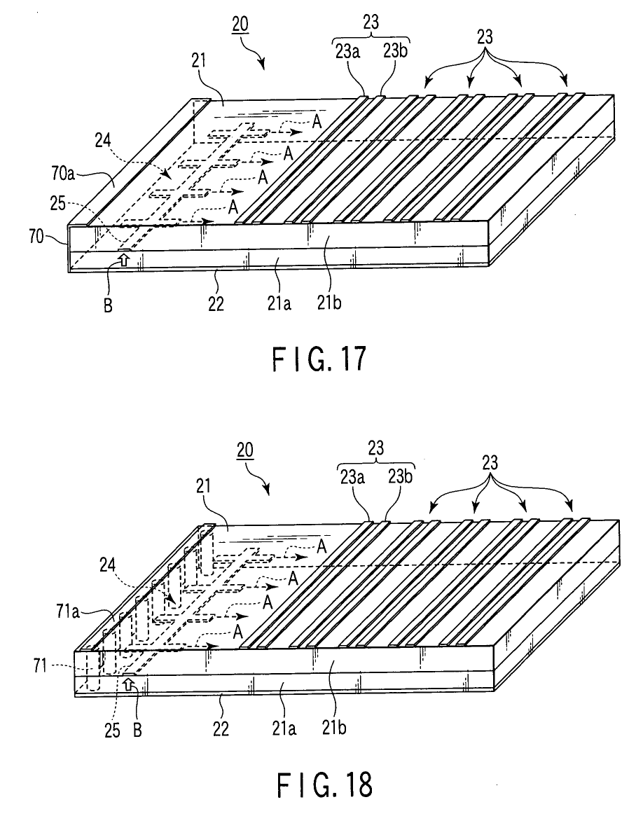

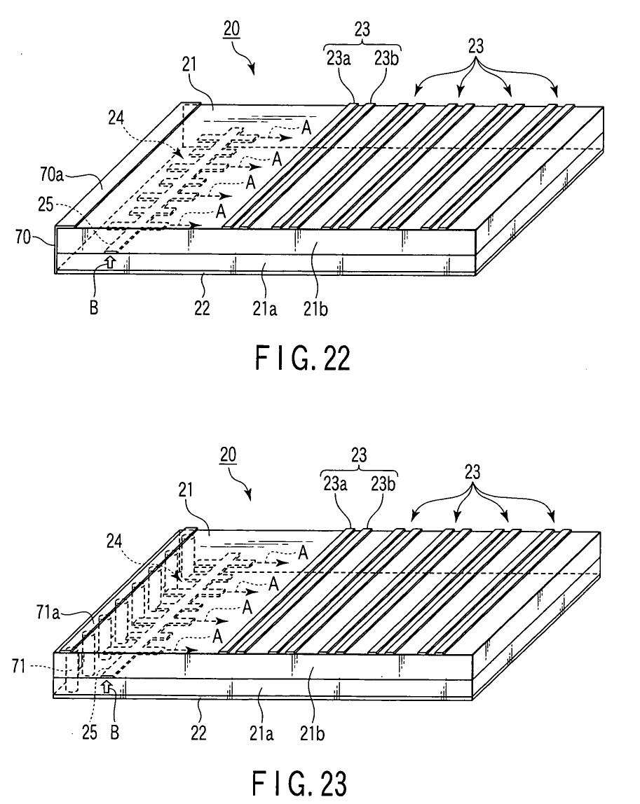

In such a case, as shown in FIG. 12, FIG. 17, or FIG. 22, a metal reflective member 70 is provided on an end face of the dielectric substrate 21 as a reflecting wall, which causes excitation waves, which are branched from the excitation section 24 having alternate stubs in FIGS. 1 to 4, the excitation section 24 having symmetric stubs in FIG. 5, or the excitation section 24 having reflex suppression elements in FIG. 6 to a side opposite to the side at which the plurality of metal strips for leakage 23 are provided, to be reflected to the side at which the plurality of metal strips for leakage 23 are provided. Therefore, it is possible to suppress deterioration in the radiant efficiency as the entire antenna.

Note that, when the reflective member 70 is formed by printing, an auxiliary member 70a is formed in a pattern on the surface of the dielectric substrate 21 (the upper surface of the upper layer 21b) as shown in FIG. 12, FIG. 17, or FIG. 22, the configuration can be made such that undesired peeling or the like of the reflective member 70 are prevented from occurring.

That is, FIG. 12 is a diagram showing an example in which a reflective member is provided in the first embodiment using the excitation section 24 having alternate stubs to which the dielectric leaky wave antenna according to the invention is applied.

FIG. 17 is a diagram showing an example in which a reflective member is provided in the second embodiment using the excitation section 24 having symmetric stubs to which the dielectric leaky wave antenna according to the invention is applied.

Further, FIG. 22 is a diagram showing an example in which a reflective member is provided in the third embodiment using the excitation section 24 having reflex suppression elements to which the dielectric leaky wave antenna according to the invention is applied.

Moreover, instead of providing the reflective member 70 on the end face as described above, as shown in FIG. 13, FIG. 18, or FIG. 28, a reflecting wall is formed in such a manner that metal pins 71 penetrating through the dielectric substrate 21 are arranged along the length direction of the metal strip for guide 40 at an interval sufficiently shorter than a wavelength of the excitation wave by a through-hole process or the like. As a consequence, it is possible to allow the excitation wave branched from the excitation section 24 having alternate stubs in FIGS. 1 to 4, the excitation section 24 having symmetric stubs in FIG. 5, or the excitation section 24 having reflex suppression elements in FIG. 6 to a side opposite to the side at which the plurality of metal strips for leakage 23 are provided, to be reflected to the side at which the plurality of metal strips for leakage 23 are provided.

Namely, FIG. 13 is a diagram showing an example in which a reflecting wall composed of the metal pins is provided in the first embodiment using the excitation section 24 having alternate stubs to which the dielectric leaky wave antenna according to the invention is applied.

Further, FIG. 18 is a diagram showing an example in which a reflecting wall composed of the metal pins is provided in the second embodiment using the excitation section 24 having symmetric stubs to which the dielectric leaky wave antenna according to the invention is applied.

FIG. 23 is a diagram showing an example in which a reflecting wall composed of the metal pins is provided in the third embodiment using the excitation section 24 having reflex suppression elements to which the dielectric leaky wave antenna according to the invention is applied.

Note that, in FIG. 13, FIG. 18, or FIG. 23, one end sides of the metal pins 71 are electrically connected to the ground conductor 22, and the other end sides are also electrically connected with a short-circuiting member 71a formed in a pattern on the surface of the dielectric substrate 21.

However, such a short-circuiting member 71a is not necessarily required, and can be omitted in some cases.

Also when the reflective member 70 and the metal pins 71 are used, in the same manner as described above, positions of the respective portions are set such that phases of reflected waves which reflect from the end face 21c of the dielectric substrate 21, and go toward the side at which the plurality of metal strips for leakage 23 are provided, and excitation waves which go directly toward the side at which the plurality of metal strips for leakage 23 are provided from the metal strip for guide 40 accord with one another.

Further, even when the excitation section is provided in the inside of the excitation section dielectric substrate 21 in the antenna having an edge feeding system shown in FIG. 4, FIG. 5, or FIG. 6, there are electromagnetic components directly radiated from the surface of the dielectric substrate 21 in an open type guide such as the microstrip line formed by the metal strip for guide 40. Thus, the radiant characteristic of the entire antenna is disturbed by the components in some cases.

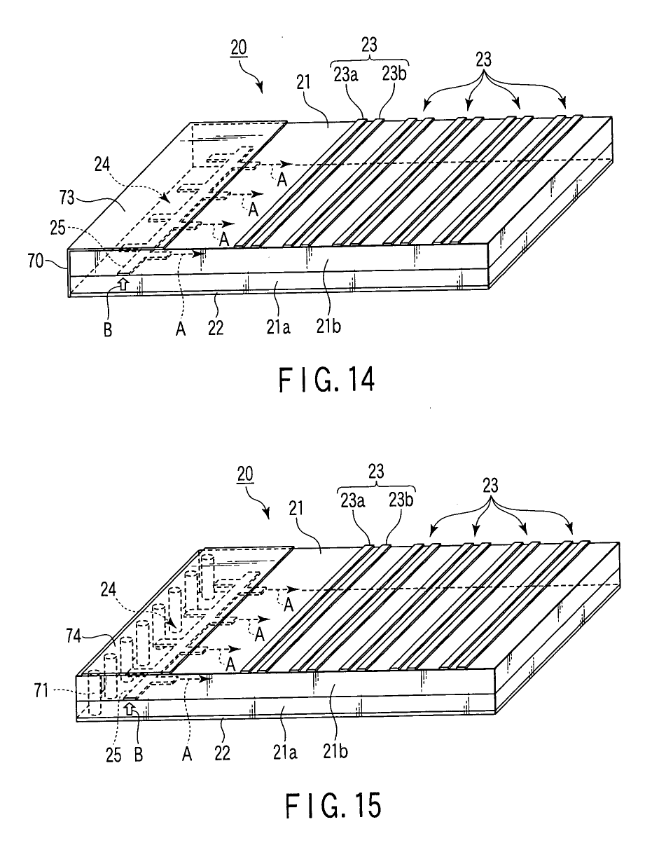

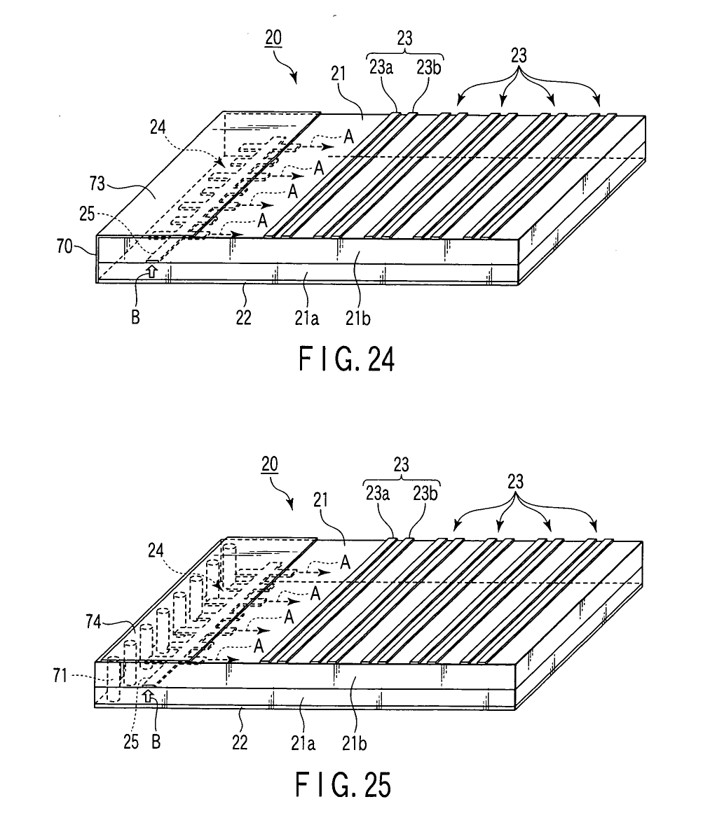

In the case where the effect by the direct radiant characteristic cannot be ignored, it suffices, as shown in FIGS. 14 and 15, FIGS. 19 and 20, or FIGS. 24 and 25, to shield the portions of the metal strip for guide 40 and the stubs 41 and 51 configuring the excitation section 24 having alternate stubs in FIGS. 1 to 4, the excitation section 24 having symmetric stubs in FIG. 5, or the excitation section 24 having reflex suppression elements in FIG. 6, with shield members 73 and 74 in which the auxiliary member 70a and the short-circuiting member 71a described above are extended to the side of the plurality of metal strips for leakage 23.

Namely, FIG. 14 is a diagram showing an example in which a shield member is provided in the first embodiment using the excitation section 24 having alternate stubs to which the dielectric leaky wave antenna according to the invention is applied.

Further, FIG. 15 is a diagram showing an example in which a reflecting wall composed of the metal pins and a shield member are provided in the first embodiment using the excitation section 24 having alternate stubs to which the dielectric leaky wave antenna according to the invention is applied.

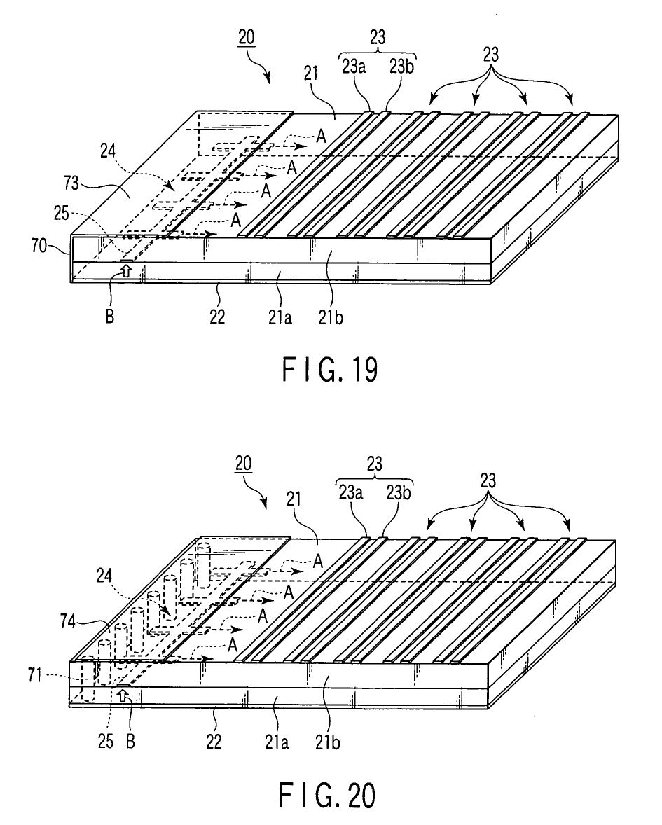

FIG. 19 is a diagram showing an example in which a shield member is provided in the second embodiment using the excitation section 24 having symmetric stubs to which the dielectric leaky wave antenna according to the invention is applied.

FIG. 20 is a diagram showing an example in which a reflecting wall composed of the metal pins and a shield member are provided in the second embodiment using the excitation section 24 having symmetric stubs to which the dielectric leaky wave antenna according to the invention is applied.

FIG. 24 is a diagram showing an example in which a shield member is provided in the third embodiment using the excitation section 24 having reflex suppression elements to which the dielectric leaky wave antenna according to the invention is applied.

FIG. 25 is a diagram showing an example in which a reflecting wall composed of the metal pins and a shield member are provided in the third embodiment using the excitation section 24 having reflex suppression elements to which the dielectric leaky wave antenna according to the invention is applied.

Further, as a dielectric leaky wave antenna 80 shown in FIG. 16, 21 or 26, the excitation section 24 including the metal strip for guide 40 and the stubs 41 and 51 which configure the excitation section 24 having alternate stubs in FIGS. 1 to 4, the excitation section 24 having symmetric stubs in FIG. 5, or the excitation section 24 having reflex suppression elements in FIG. 6 can be provided in the inside at the center of the dielectric substrate 21, and a plurality of metal strips for leakage 23 and 23′ can be respectively arranged in parallel to one another at the both sides thereof.

Namely, FIG. 16 is a diagram showing an example in which the plurality of metal strips for leakage 23 and 23′ are respectively provided at the both sides of the metal strip for guide 40 to which edge feeding is carried out in the first embodiment using the excitation section 24 having alternate stubs to which the dielectric leaky wave antenna according to the invention is applied.

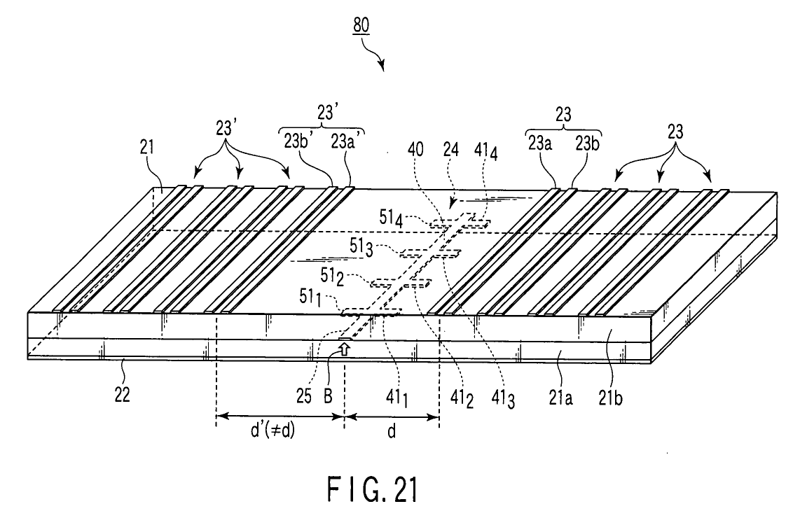

FIG. 21 is a diagram showing an example in which the plurality of metal strips for leakage 23 and 23′ are respectively provided at the both sides of the metal strip for guide 40 to which edge feeding is carried out in the second embodiment using the excitation section 24 having symmetric stubs to which the dielectric leaky wave antenna according to the invention is applied.

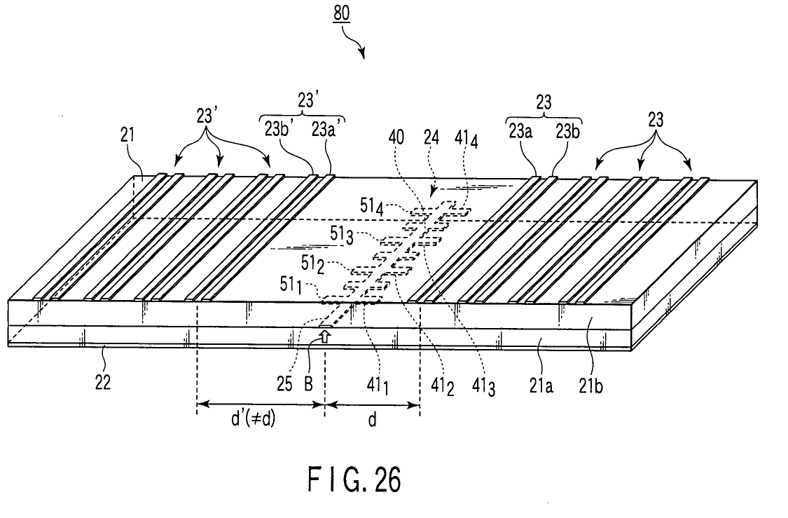

FIG. 26 is a diagram showing an example in which the plurality of metal strips for leakage 23 and 23′ are provided at the both sides of the metal strip for guide 40 to which edge feeding is carried out in the third embodiment using the excitation section 24 having reflex suppression elements to which the dielectric leaky wave antenna according to the invention is applied.

However, because a phase difference is generated in the respective electromagnetic radiation branched to right and left, it is necessary to adjust distances d and d′ from the metal strip for guide 40 to the first right-and-left metal strips for leakage 23 and 23′.

More specifically, in the case of FIG. 16, a phase difference which is substantially equal to one fourth the guide wavelength λg′ is generated in the respective electromagnetic radiation branched to right and left. Therefore, if the above-described distances d and d′ are set to d′=d+(λg′/4), electromagnetic radiation in phase can be made to leak from the respective metal strips for leakage 23 and 23′ on the right and left.

Further, in the case of FIG. 21 or FIG. 26, a phase difference which is substantially equal to ½ the guide wavelength λg′ is generated in the respective electromagnetic radiation branched to right and left. For this reason, if the above-described distances d and d′ are set to d′=d+(λg′/2), electromagnetic radiation in phase can be made to leak from the respective metal strips for leakage 23 and 23′ on the right and left.

### FOURTH EMBODIMENT

The dielectric leaky wave antenna 20 according to the first to third embodiments and the modified example thereof have been shown in the cases of the edge feeding system in which electromagnetic radiation is supplied from the feed point 25 at the one end side of the microstrip line.

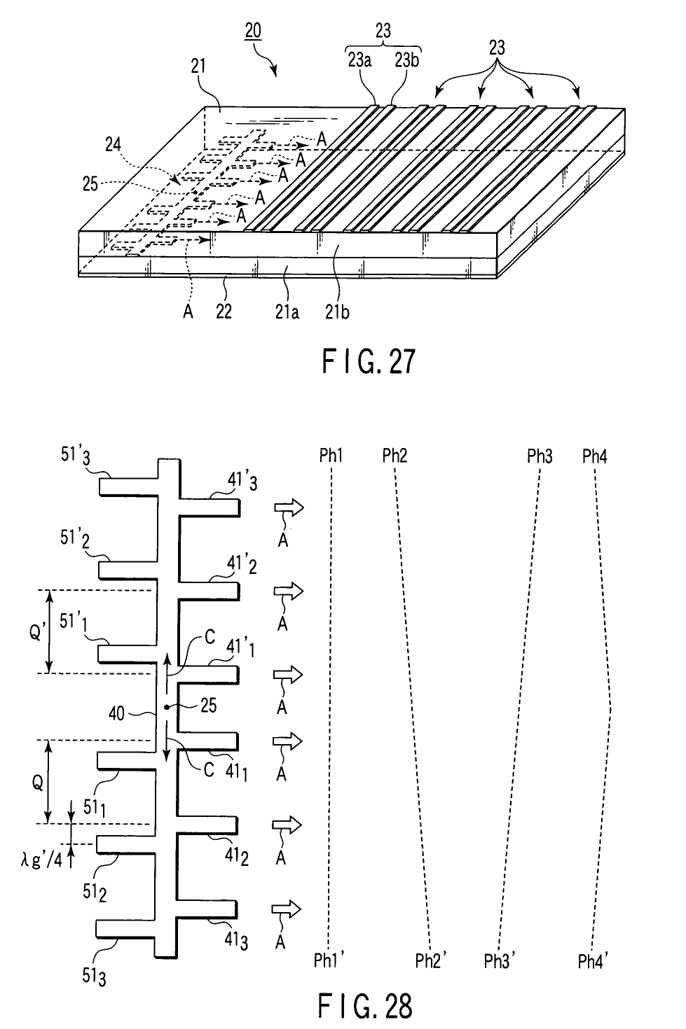

However, as shown in FIG. 27 on and after, those may be a center feeding system in which electromagnetic radiation is supplied from the feed point 25 at a central portion of the microstrip line.

Also in the case of such a center feeding system, it is possible to control the distribution of the electromagnetic radiation branched to be output into the dielectric substrate 21 by setting widths and lengths of the stubs 41 and 51 in the excitation sections 24 appropriately.

FIG. 27 is a perspective view showing a configuration of a fourth embodiment using the excitation section 24 having alternate stubs by a center feeding system to which the dielectric leaky wave antenna of the invention is applied.

In FIG. 27, the other configuration is the same as that in the edge feeding system in which electromagnetic radiation is supplied from the feed point 25 at one end side of the microstrip line shown in FIG. 1, except that this embodiment is constituted as a center feeding system in which electromagnetic radiation is supplied from the feed point 25 at a central portion of the microstrip line.

FIG. 28 is a diagram for explaining a configuration and operations of a principal part in the fourth embodiment using the excitation section 24 having alternate stubs by center feeding to which the dielectric leaky wave antenna of the invention is applied.

In this case, as shown in the left of FIG. 28, a phase front of the excitation waves can be arbitrarily set in accordance with an interval Q from the feed point 25 to the first stubs 41₁ to 41₃ at one side, and an interval Q′ from the feed point 25 to first stubs 41₁′ to 41₃′ at the other side.

In this case, each of the second stubs 51₁ to 51₃ and second stubs 51₁′ to 51₃′ functions for reflex suppression in the same manner as described above.

For example, when stub intervals Q and Q′ are set to be equal to an integer multiple of the guide wavelength λg′ (Q=Q′=λg′), a phase front Ph1-Ph1′ which is parallel to the metal strip for guide 40 is obtained as shown in the right of FIG. 28.

Further, when the stub interval Q is set to be shorter than an integer multiple of the guide wavelength λg′, and the stub interval Q′ is set to be longer than an integer multiple of the guide wavelength λg′ (Q<λg′<Q′), a phase front Ph2-Ph2′ which is slightly inclined toward the metal strip for guide 40 is obtained.

In contrast thereto, when the stub interval Q is set to be longer than an integer multiple of the guide wavelength λg′, and the stub interval Q′ is set to be shorter than an integer multiple of the guide wavelength λg′, (Q>λg′>Q′), a phase front Ph3-Ph3′ which is slightly inclined in the opposite direction of the phase front Ph2-Ph2′ toward the metal strip for guide 40 is obtained.

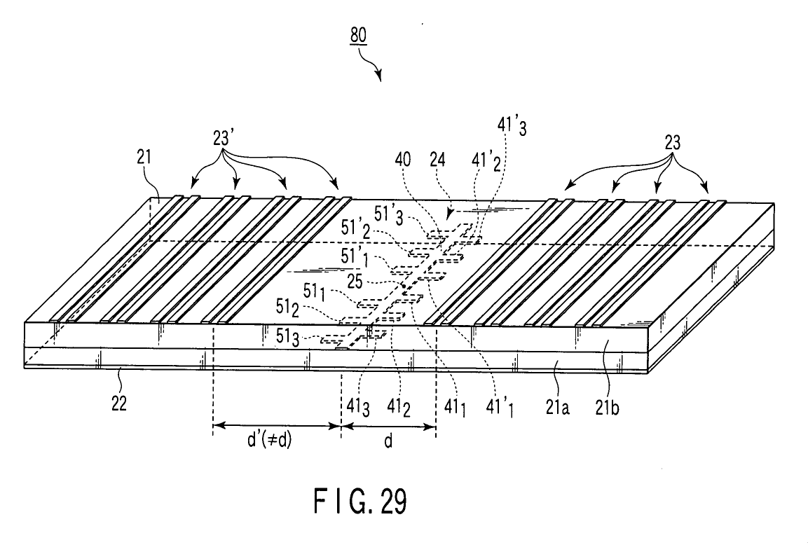

FIG. 29 is a diagram showing an example in which the plurality of metal strips for leakage 23 and 23′ are provided at the both sides of the metal strip for guide 40 to which center feeding is carried out in the fourth embodiment using the excitation section 24 having alternate stubs to which the dielectric leaky wave antenna according to the invention is applied.

In FIG. 29, the other configuration is the same as that of the edge feeding system in which electromagnetic radiation is supplied from the feed point 25 at one end side of the microstrip line shown in FIG. 16, except that this embodiment is constituted as a center feeding system in which electromagnetic radiation is supplied from the feed point 25 at a central portion of the microstrip line.

In the case of such a center feeding system, a loss (a conductor loss or a dielectric loss) occurring in the guide is made to be substantially half when a length of the microstrip line is the same as that in the edge feeding described above, so that the performance as the antenna is enhanced.

Further, even when there are manufacturing errors or the like in the case where the phase front Ph1-Ph1′ parallel to the metal strip for guide 40 is obtained, the phase front Ph1-Ph1′ is inclined symmetrically as the phase front Ph4-Ph4′ shown in the right of FIG. 28 if these errors are brought about symmetrically with respect to the feed point. Consequently, a central beam direction is not greatly shifted.

### FIFTH EMBODIMENT

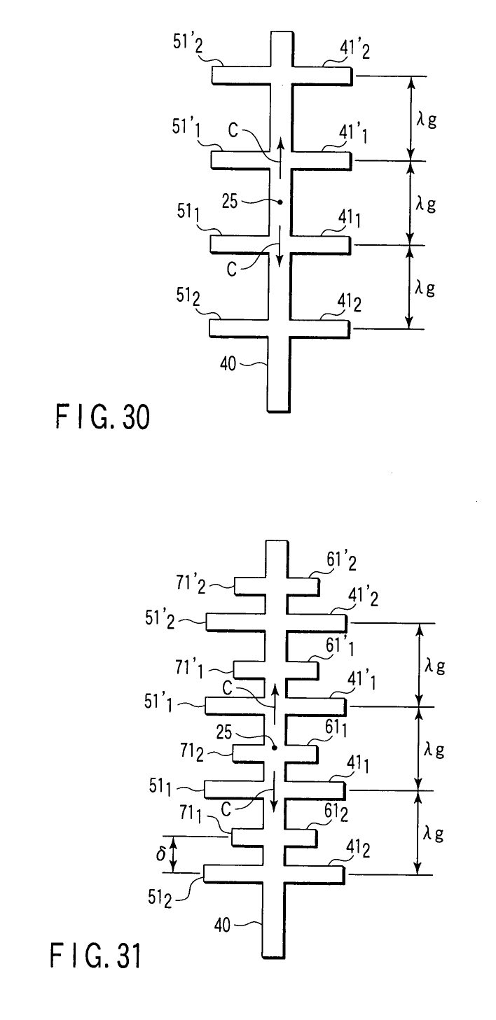

FIG. 30 is a diagram showing the excitation section 24 having symmetric stubs as a configuration of a principal part in a fifth embodiment by center feeding to which the dielectric leaky wave antenna of the invention is applied.

In FIG. 30, the other configuration is the same as that of the edge feeding system in which electromagnetic radiation is supplied from the feed point 25 at one end side of the microstrip line shown in FIG. 5, except that this embodiment is constituted as a center feeding system in which electromagnetic radiation is supplied from the feed point 25 at a central portion of the microstrip line.

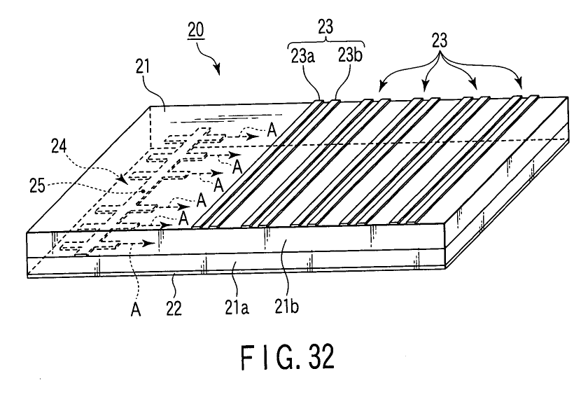

FIG. 32 is a perspective view showing a configuration of the fifth embodiment using the excitation section 24 having symmetric stubs by center feeding to which a dielectric leaky wave antenna of the invention is applied.

In FIG. 32, the other configuration is the same as that of the edge feeding system in which electromagnetic radiation is supplied from the feed point 25 at one end side of the microstrip line shown in FIG. 1, except that the excitation section 24 having symmetric stubs is used in place of the excitation section 24 having alternate stubs, and that this embodiment is constituted as a center feeding system in which electromagnetic radiation is supplied from the feed point 25 at a central portion of the microstrip line.

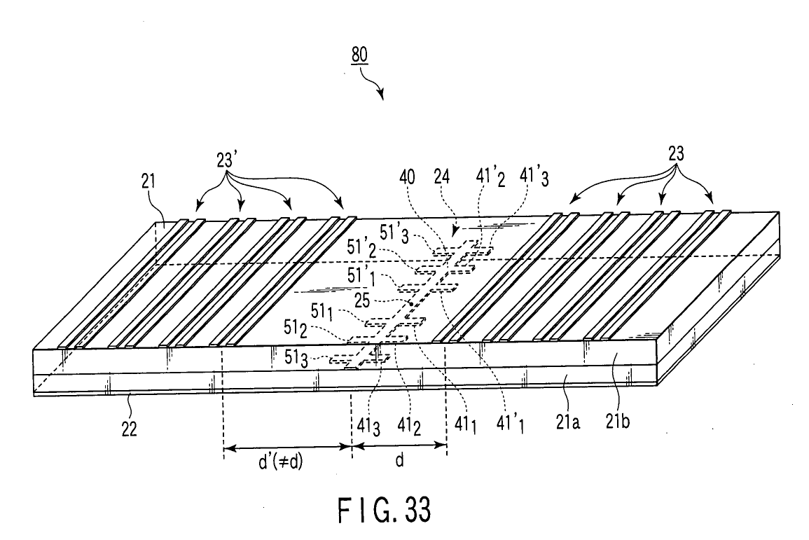

FIG. 33 is a diagram showing an example in which the plurality of metal strips for leakage 23 and 23′ are provided at the both sides of the metal strip for guide 40 to which center feeding is carried out in the fifth embodiment to which the dielectric leaky wave antenna according to the invention is applied.

In FIG. 33, the other configuration is the same as that of the edge feeding system in which electromagnetic radiation is supplied from the feed point 25 at one end side of the microstrip line shown in FIG. 16, except that the excitation section 24 having symmetric stubs is used in place of the excitation section 24 having alternate stubs, and that this embodiment is constituted as a center feeding system in which electromagnetic radiation is supplied from the feed point 25 at a central portion of the microstrip line.

### SIXTH EMBODIMENT

FIG. 31 is a diagram showing an excitation section 24 having reflex suppression elements as a configuration of a principal part in a sixth embodiment by center feeding to which the dielectric leaky wave antenna of the invention is applied.

In FIG. 31, the other configuration is the same as that of the edge feeding system in which electromagnetic radiation is supplied from the feed point 25 at one end side of the microstrip line shown in FIG. 6, except that this embodiment is constituted as a center feeding system in which electromagnetic radiation is supplied from the feed point 25 at a central portion of the microstrip line.

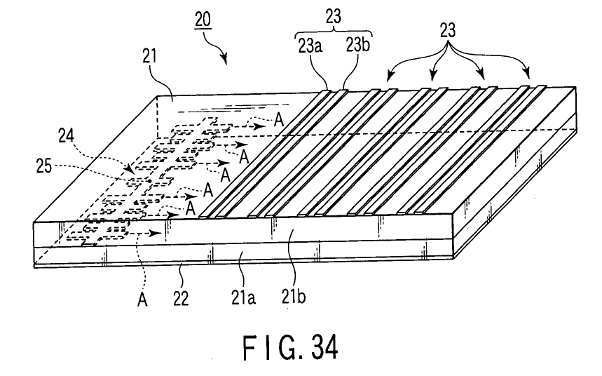

FIG. 34 is a perspective view showing a configuration of the sixth embodiment by center feeding to which the dielectric leaky wave antenna of the invention is applied.

In FIG. 34, the other configuration is the same as that of the edge feeding system in which electromagnetic radiation is supplied from the feed point 25 at one end side of the microstrip line shown in FIG. 1, except that the excitation section 24 having reflex suppression elements is used in place of the excitation section 24 having alternate stubs, and that this embodiment is constituted as a center feeding system in which electromagnetic radiation is supplied from the feed point 25 at a central portion of the microstrip line.

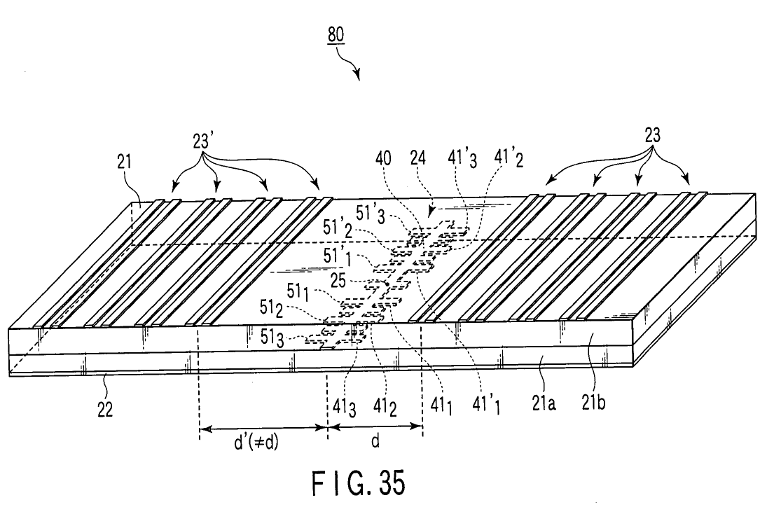

FIG. 35 is a diagram showing an example in which the plurality of metal strips for leakage 23 and 23′ are provided at the both sides of the metal strip for guide 40 to which center feeding is carried out in the sixth embodiment to which the dielectric leaky wave antenna according to the invention is applied.

In FIG. 35, the other configuration is the same as that of the edge feeding system in which electromagnetic radiation is supplied from the feed point 25 at one end side of the microstrip line shown in FIG. 16, except that the excitation section 24 having reflex suppression elements is used in place of the excitation section 24 having alternate stubs, and that this embodiment is constituted as a center feeding system in which electromagnetic radiation is supplied from the feed point 25 at a central portion of the microstrip line.

### SEVENTH EMBODIMENT

FIG. 36 is a diagram showing an example of an antenna of 45° polarization as the seventh embodiment to which the dielectric leaky wave antenna according to the invention is applied.

More specifically, in the respective dielectric leaky wave antennas described above, the metal strips for leakage 23 and 23′ and the metal strip for guide 40 are formed so as to be substantially parallel to one side of the rectangular dielectric substrate 21.

However, the present invention is not limited thereto, and orientations of the metal strips for leakage 23 and 23′ and the metal strip for guide 40 with respect to the shape of the dielectric substrate 21 can be arbitrarily set.

For example, as shown in FIG. 36, the metal strip for guide 40 may be provided so as to accord with the diagonal thereof between the lower layer portion 21a and the upper layer portion 21b of the square dielectric substrate 21, and the stubs 41 and 51 may be provided to the side edges at the both sides thereof, and the plurality of metal strips for leakage 23 and 23′ may be respectively provided so as to parallel to one another at the both sides thereof and on the surface of the dielectric substrate 21.

In this case, if electromagnetic radiation with a phase front parallel to the metal strips for leakage 23 and 23′ at the both sides is propagated from the excitation section 24, it is possible to allow electromagnetic radiation with polarization perpendicular to the length direction to leak from the metal strips for leakage 23 and 23′.

A direction of the polarization of the electromagnetic radiation is made to be 45° polarization which is inclined at 45° on the basis of one side of the rectangular dielectric substrate 21, which is suitable for a automobile radar or the like.

(Modified Examples of Excitation Section)

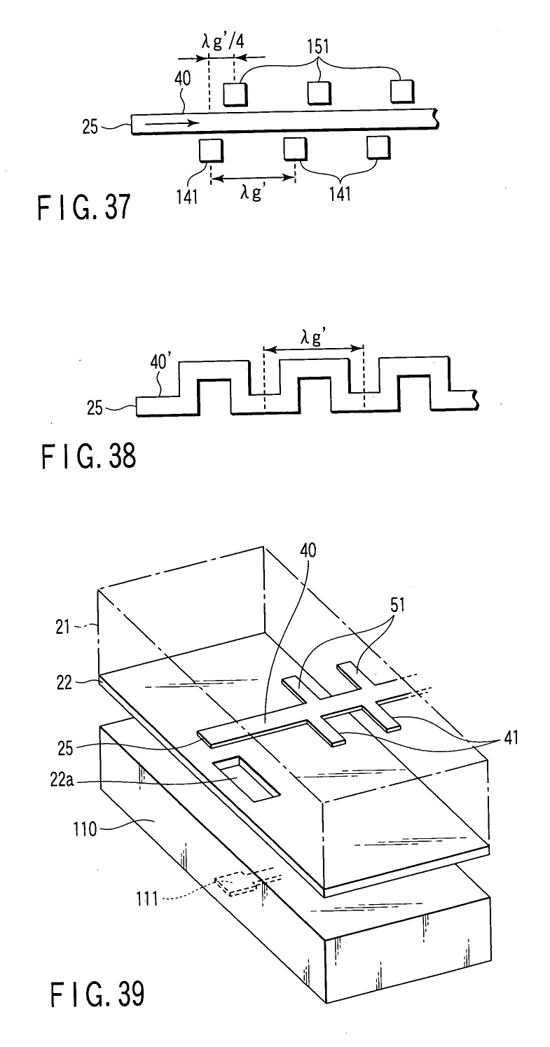

FIG. 37 is a diagram showing a modified example of the excitation sections in the respective embodiments to which the dielectric leaky wave antenna according to the invention is applied.

Namely, in the respective embodiments described above, the stubs 41 and 51 projected from the side edges of the metal strip for guide 40 are used as the branching means 24A for branching and outputting electromagnetic radiation propagated in the microstrip line constituted by the metal strip for guide 40 and the ground conductor 22 toward the side of the metal strips for leakage 23.

However, the present invention is not limited thereto, as shown in FIG. 37, the present invention may be configured such that first stubs 141 and second stubs 151 which are separated from the metal strip for guide 40 are used.

FIG. 38 is a diagram showing another modified example of the excitation sections in the respective embodiments to which the dielectric leaky wave antenna according to the invention is applied.

In other words, not only the stubs as described above, as shown in FIG. 38, a metal strip for guide 40′ itself may have a rectangular (may be trapezoidal) bent structure which is repeated, for example, in cycles of a length of an integer multiple n·λg of the guide wavelength λg, and an electric wave may be branched to be output to the side of the metal strips for leakage 23 from bent portions of the microstrip line formed by the bent metal strip for guide 40.

In this example, branching means is provided to the metal strip for guide 40′ itself. The invention is not limited to the above-described example, and branching means can be achieved by periodically perturbing to the metal strip for guide.

(Embodiment of Feed Unit)

In the dielectric leaky wave antennas 20 and 80 in the respective embodiments described above, description of the configuration itself of the feed point 25 of the excitation section 24 formed in the dielectric substrate 21, i.e., of the feed unit has been omitted.

However, with respect to the structure of the feed unit, feeding can be carried out via a slot or a metal pin formed by through-hole plating or the like from the lower surface side of the ground conductor 22.

FIG. 39 is a diagram showing a configuration example when edge feeding is carried out via a slot from the lower surface side of the ground conductor 22 in the first to third embodiments by an edge feeding system to which the dielectric leaky wave antenna according to the invention is applied.

For example, in the case of edge feeding, the configuration is made as shown in FIG. 39. That is, a slot 22a is provided at a position facing one end (the feed point 25) of the metal strip for guide 40 of the ground conductor 22. In addition, an electrode section 111 and the one end side of the metal strip for guide 40 of the ground conductor 22 are coupled via the slot 22a. The electrode section 111 is formed in a pattern on a circuit board 110 provided so as to be joined to be overlapped on the ground conductor 22 with no space, and is connected to an output line of a transmission section or an input line of a reception section on the circuit board 110.

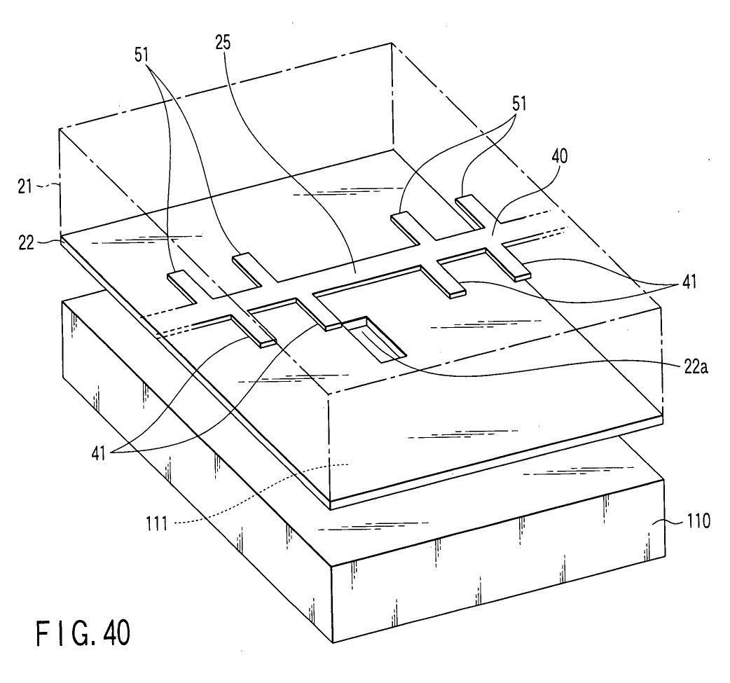

FIG. 40 is a diagram showing a configuration example when center feeding is carried out via a slot in the fourth embodiment by center feeding to which the dielectric leaky wave antenna according to the invention is applied.

Further, in the case of center feeding, the configuration is made as shown in FIG. 40. That is, the slot 22a is provided at a position facing a central portion (the feed point 25) of the metal strip for guide 40 of the ground conductor 22. In addition, the electrode section 111 and the central portion of the metal strip for guide 40 of the ground conductor 22 are coupled via the slot 22a. The electrode section 111 is formed in a pattern on the circuit board 110 provided so as to be joined to be overlapped on the ground conductor 22 with no space, and is connected to an output line of a transmission section or an input line of a reception section.

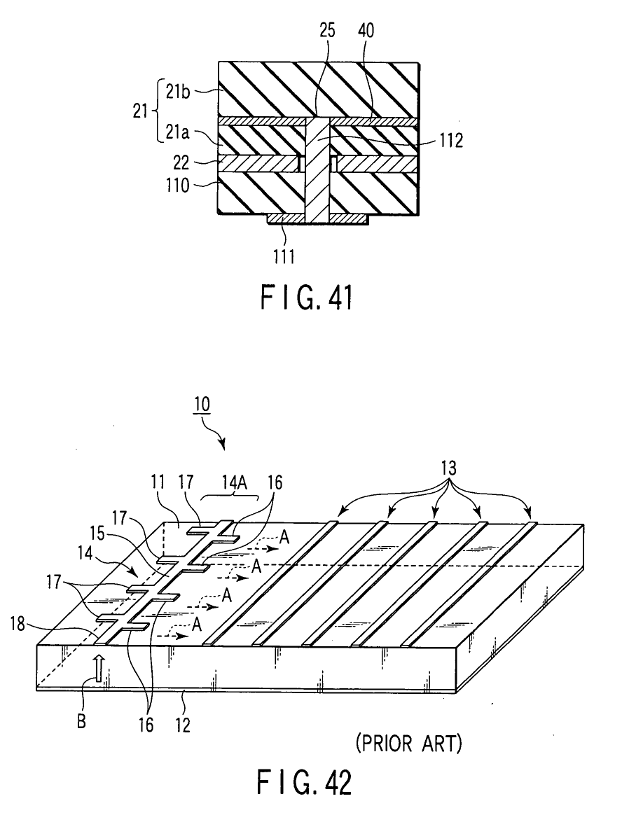

FIG. 41 is a diagram showing a configuration example when feeding is carried out via a metal pin in the respective embodiments to which the dielectric leaky wave antenna according to the invention is applied.

Namely, as shown in FIG. 41, the feed point 25 of the metal strip for guide (which may be in any of edge feeding and center feeding), and the electrode section 111 on the circuit board 110 may be connected by using a metal pin 112 penetrating through the lower layer portion 21a, the ground conductor 22, and the circuit board 110 from the feed point 25 of the metal strip for guide formed on the lower layer portion 21a of the dielectric substrate 21.

In accordance with the present invention as described above, it is possible to provide a dielectric leaky wave antenna improved in efficiency which solves the problem in the prior art as described above, and which satisfies both of a transmission characteristic of a dielectric image guide for a radiation section, and a transmission characteristic of a microstrip line for an excitation section.

1. A dielectric leaky wave antenna characterized by comprising:
a dielectric substrate;
a ground conductor provided on one surface side of the dielectric substrate, the ground conductor forming a dielectric image guide which propagates electromagnetic radiation in a direction perpendicular to a thickness direction in the dielectric substrate;
a plurality of metal strips for leakage provided in parallel to one another at predetermined intervals on an opposite surface side of the dielectric substrate; and
an excitation section having a metal strip for guide which forms a microstrip line between itself and the ground conductor and branching means for branching electromagnetic radiation transmitted in the microstrip line in a direction perpendicular to the plurality of metal strips for leakage in the dielectric substrate, wherein
the dielectric substrate is configured to have a lower layer portion and an upper layer portion joined on the lower layer portion,
the ground conductor is formed on a lower surface of the lower layer portion of the dielectric substrate,
the plurality of metal strips for leakage are formed on an upper surface of the upper layer portion of the dielectric substrate, and
the metal strip for guide and the branching means which configure the excitation section are formed between the lower layer portion and the upper layer portion of the dielectric substrate.

2. The dielectric leaky wave antenna according to claim 1, characterized in that
the branching means of the excitation section has:
a plurality of first stubs provided at predetermined intervals to an edge at one side of the metal strip for guide, the first stubs branching and outputting electromagnetic radiation, which is fed to the microstrip line and is propagated in a longitudinal direction of the microstrip line, in a direction perpendicular to the metal strips for leakage; and
a plurality of second stubs provided at predetermined intervals to an edge at the other side of the metal strip for guide, the second stubs branching and outputting electromagnetic radiation, which is fed to the microstrip line and is propagated in a longitudinal direction of the microstrip line, in a direction perpendicular to the metal strips for leakage, and
the predetermined intervals at which the plurality of first stubs and the plurality of second stubs are provided are equal to a guide wavelength of the electromagnetic radiation propagated in the microstrip line.

3. The dielectric leaky wave antenna according to claim 2, characterized in that
the plurality of first stubs and the plurality of second stubs are respectively provided such that corresponding stubs are shifted by substantially one fourth the guide wavelength of the electromagnetic radiation propagated in the microstrip line.

4. The dielectric leaky wave antenna according to claim 2, characterized in that
the plurality of first stubs and the plurality of second stubs are respectively provided at positions symmetric with respect to the metal strip for guide.

5. The dielectric leaky wave antenna according to claim 4, characterized in that
the branching means of the excitation section is provided with a plurality of reflex suppression elements respectively provided at positions symmetric with respect to the metal strip for guide at predetermined intervals respectively from the plurality of first stubs and the plurality of second stubs.

6. The dielectric leaky wave antenna according to claim 2, characterized in that
the plurality of first stubs and the plurality of second stubs are formed in band shapes extending by predetermined distances in a direction perpendicular to the metal strip for guide respectively with predetermined widths from the side edges of the metal strip for guide.

7. The dielectric leaky wave antenna according to claim 5, characterized in that
the plurality of reflex suppression elements are formed in band shapes extending by predetermined distances in a direction perpendicular to the metal strip for guide respectively with predetermined widths from the side edges of the metal strip for guide.

8. The dielectric leaky wave antenna according to claim 1, characterized by further comprising
a reflecting wall to reflect the electromagnetic radiation branched toward a side opposite to a side of the metal strips for leakage by the branching means, toward the side of the metal strips for leakage.

9. The dielectric leaky wave antenna according to claim 1, characterized by further comprising
a shield member having one end electrically connected to the ground conductor, and the other end extended so as to face the metal strip for guide at an opposite surface side of the dielectric substrate, the shield member shielding electromagnetic radiation directly radiated from the microstrip line to the opposite surface side of the dielectric substrate.

10. The dielectric leaky wave antenna according to claim 1, characterized in that
the excitation section is provided at a substantially central portion of the dielectric substrate, and the plurality of metal strips for leakage are respectively provided at both sides of the excitation section.

11. The dielectric leaky wave antenna according to claim 1, characterized in that
the microstrip line is configured to propagate electromagnetic radiation fed from one end of the microstrip line to the other end of the microstrip line.

12. The dielectric leaky wave antenna according to claim 1, characterized in that
the microstrip line is configured to propagate electromagnetic radiation fed from a substantially center of the microstrip line to both end sides of the microstrip line.

13. The dielectric leaky wave antenna according to claim 1, characterized in that
a circuit board is provided at an opposite side of the dielectric substrate with respect to the ground conductor, and an electrode section of the circuit board and a part of the metal strip for guide are connected via a slot formed in the ground conductor.

14. The dielectric leaky wave antenna according to claim 1, characterized in that
a circuit board is provided at an opposite side of the dielectric substrate with respect to the ground conductor, and an electrode section of the circuit board and a part of the metal strip for guide are connected via a metal pin formed so as to penetrate through the lower layer portion of the dielectric substrate, the ground conductor, and the circuit board.

15. The dielectric leaky wave antenna according to claim 1, characterized in that
the metal strip for guide and the branching means which configure the excitation section are formed by a print process on an upper surface of the lower layer portion or a lower surface of the upper layer portion of the dielectric substrate.
